(19) United States
(12) Patent Application Publication
(10) Pub. No.: US 2015/0229644 A1
(43) Pub. Date: Aug. 13, 2015

(54) ACCESS CONTROL METHOD AND ACCESS CONTROL SYSTEM

(71) Applicant: HITACHI, LTD., Tokyo (JP)

(72) Inventors: Takahiro Nozawa, Tokyo (JP); Naotsugu Toume, Tokyo (JP); Yuji Mizote, Tokyo (JP)

(73) Assignee: HITACHI, LTD., Tokyo (JP)

(21) Appl. No.: 14/427,612

(22) PCT Filed: Nov. 5, 2012
(86) PCT No.: PCT/JP2012/078644

§ 371 Date: Mar. 11, 2015

(51) Int. Cl. H04L 29/06; G06Q 10/06

(52) U.S. Cl. CPC H04L 63/10; G06Q 10/063

(57) ABSTRACT

Provided is an access control method of a terminal which is coupled with an administration device in a schedule storage unit, location information corresponding to a timestamp of a possessor of a terminal. The terminal acquires location information and timestamp information, and transmits to the administration device an identifier of the possessor of the terminal, the location information, and the timestamp information. The administration device compares the received user's identifier, the received location information, and the received timestamp information, with location information which corresponds to the timestamp of the possessor. If it is determined that a conflict has occurred with the location information and the timestamp information, a current task state of the possessor is estimated from history information of a person associated with the possessor, and the task state is transmitted to the terminal. The terminal controls access to applications and data according to the received task state.

### BACKGROUND

The present invention is related to an access control technology utilizing schedule information and location information.

In recent years, there has been a rapid increase of cases where people utilize smart devices (smart phones and tablet terminal devices) for business purposes. On the other hand, there arises new issues where confidential information is leaked via unauthorized use by third parties when the smart devices are stolen or the like.

Before smart devices became popularized as now, data access was controlled by giving restrictions to users who are permitted to activate applications or access files in accordance with the level of secrecy of the files stored at computers. After smart devices have been popularized, in light of heightened awareness concerning the leakage of secret information, there has been a demand for device operation to prohibit activation of applications or access to information unless the user is at scheduled time and place.

For example, with the technology disclosed in Patent document 1 (JP Laid-open Patent Application No. 2006-352561), a determination is made as to whether or not user's actual activity matches the registered schedule, wherein when it is determined that they do not match, security control is implemented based on access restriction to applications and data according to a predetermined security pattern.

### SUMMARY

When the technology such as one disclosed in Patent document 1 is used, it becomes possible to implement relevant access control by using the location information of the user and the location information registered in the schedule. However, this technology presupposes the schedule to be registered correctly. Schedules are often times changed and it is not always the case the user conducts his/her business according to the schedule.

Schedules may be changed when, for example, the user forgets to register his/her schedule, a scheduled item extends longer than scheduled, or a plan is front loaded than the schedule. At such time, according to the technology disclosed in the above stated patent document 1, access may be rejected even if the access was made at an appropriate time and from an appropriate place such that the convenience of the user is compromised.

The object of the present invention is to realize the prevention of information leakage while maintaining the convenience of the user even when the user's activity differs from the registered schedule.

A representative aspect of the present disclosure is as follows. An access control method for a terminal coupled with a management apparatus having a processor and a memory, the method comprising: a first step for storing, by the management apparatus, at a schedule storage unit location information corresponding to time of an owner of the terminal; a second step for transmitting, by the terminal, after acquiring the location information and time information to the management apparatus an identifier of the owner of the terminal, the location information, and the time information; a third step for determining, by the management apparatus, an inconsistency is occurred to one of at least the location information and the time information after comparing the identifier of the owner received from the terminal, the location information, the time information with location information corresponding to time for the owner of the terminal stored at the schedule storage unit, and when location information corresponding to the time information of the terminal is in disagreement with location information corresponding to time stored at the schedule storage unit; a fourth step for transmitting, by the management apparatus, a business status to the terminal when the inconsistency is occurred after estimating a business status of the owner of the terminal from history information of a person related to the owner of the terminal; and a fifth step for controlling access, by the terminal, to an application and data according to the business status after receiving the business status.

According to the present invention, it becomes possible to prevent information leakage while maintaining the convenience of the user by implementing strict access control utilizing business schedule information and the location information of the terminal, and to allow access even when an inconsistency is occurred between the business schedule information and the location information of the terminal.

### BRIEF DESCRIPTION OF THE DRAWINGS

FIG. 1A is a block diagram illustrating an example of a computer system according to a first embodiment of this invention.

FIG. 1B is a block diagram illustrating an example of a management apparatus configuring the access control system according to the first embodiment of this invention.

FIG. 2A is a diagram illustrating an exemplary model of a process carried out by a computer system according to the first embodiment of this invention.

FIG. 2B is a diagram illustrating an exemplary model of a process carried out by the access control system according to the first embodiment of this invention.

FIG. 3 illustrates an example of a data configuration of the employee information table according to the first embodiment of this invention.

FIG. 4 is a diagram illustrating an example of a data configuration of the business schedule list according to the first embodiment of this invention.

FIG. 5 is a diagram illustrating an example of a data configuration of the behavior history table according to the first embodiment of this invention.

FIG. 6 is a diagram illustrating an example of a data configuration of the business area-location information correspondence table according to the first embodiment of this invention.

FIG. 7 is a diagram illustrating an example of a data configuration of the business context correspondence table according to the first embodiment of this invention.

FIG. 8 is a diagram illustrating an example of a data configuration of the applied policy correspondence table according to the first embodiment of this invention.

FIG. 9 is a diagram illustrating an example of a data configuration of the policy definition table according to the first embodiment of this invention.

FIG. 10 is a flowchart illustrating an example of a process performed by the business context estimation unit according to the first embodiment of this invention.

FIG. 11A is the first half of a flowchart illustrating an example of a process executed by the location information-business schedule inconsistency resolution unit according to the first embodiment of this invention.

FIG. 11B is a latter half of the flowchart illustrating the example of the process executed by the location information-business schedule inconsistency resolution unit according to the first embodiment of this invention.

FIG. 12 is a block diagram illustrating an example of a management apparatus according to a second embodiment of this invention.

FIG. 13 is a flowchart illustrating the example of the process executed by the location information-business schedule inconsistency resolution unit according to the second embodiment of this invention.

FIG. 14 is a block diagram illustrating an example of a management apparatus according to a third embodiment of this invention.

FIG. 15A is the first section of a flowchart illustrating an example of a process executed by the location information-business schedule inconsistency resolution unit according to the third embodiment of this invention.

FIG. 15B is the midsection of the flowchart illustrating an example of a process executed by the location information-business schedule inconsistency resolution unit according to the third embodiment of this invention.

FIG. 15C is the last section of the flowchart illustrating an example of a process executed by the location information-business schedule inconsistency resolution unit according to the third embodiment of this invention.

FIG. 16 is a diagram illustrating an example of a data configuration of the inconsistency history table according to the third embodiment of this invention.

### DETAILED DESCRIPTION OF THE EMBODIMENTS

Hereinafter, embodiments for carrying out the present invention will be described in detail with reference to accompanying drawings.

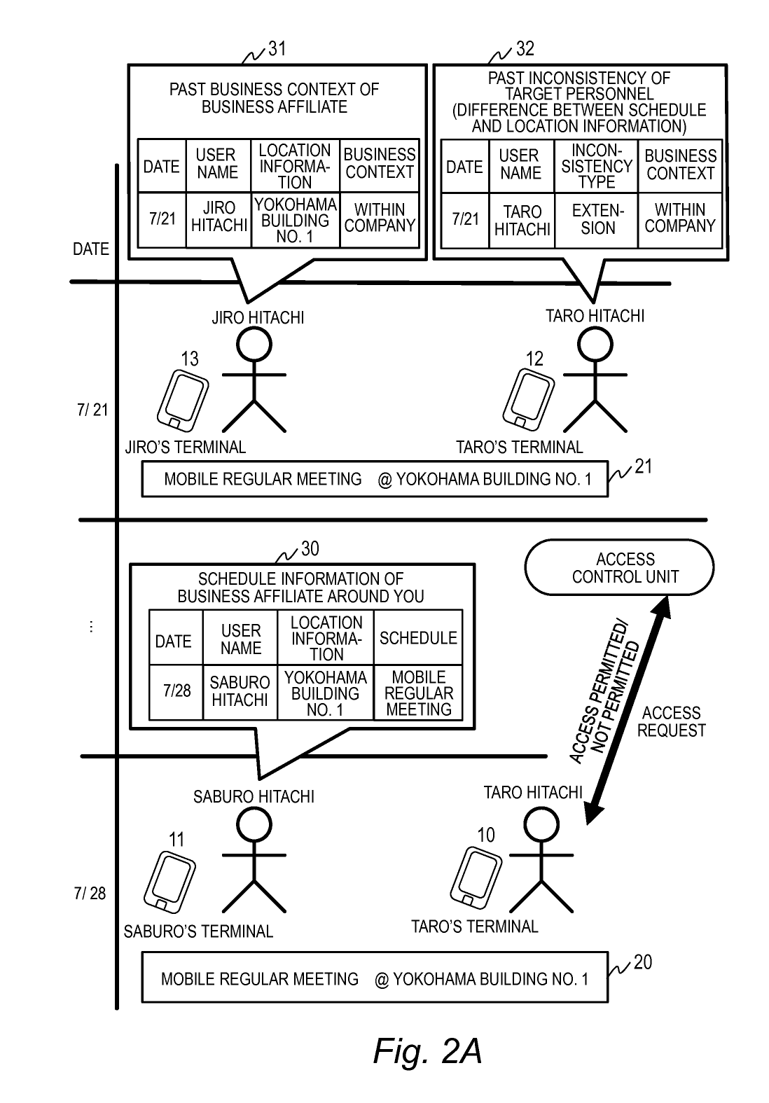

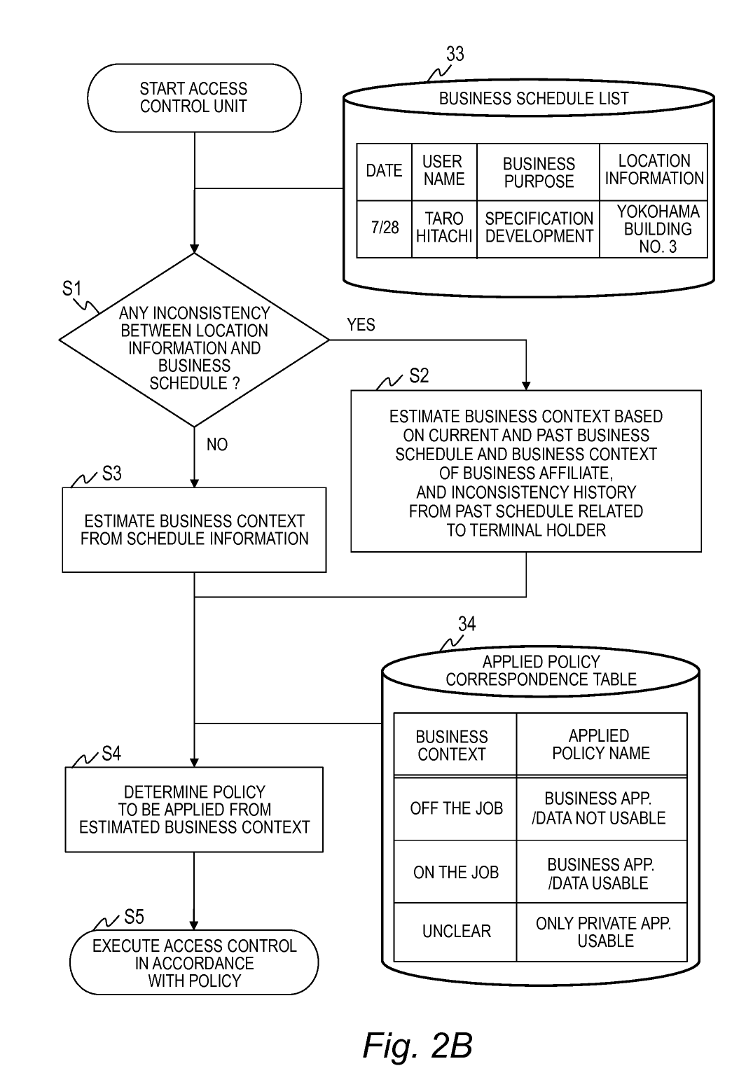

The principles of the present invention will be described with reference to the model diagram of an access control system illustrated in FIG. 2A and FIG. 2B. Note that FIG. 2A is a diagram illustrating an exemplary model of a process carried out by a computer system of the present invention, while FIG. 2B is a diagram illustrating an exemplary model of a process carried out by the access control system.

Note that FIG. 2A and FIG. 2B exemplary illustrate three embodiments out of a plurality of embodiments of the present invention designed to solve the above stated problems.

It is to be noted that, in FIG. 2A and FIG. 2B, 3 personnel: Taro HITACHI, Jiro HITACHI, and Saburo HITACHI, all work for the same company and each employee is a business affiliated of one another, wherein each employee (user) retains terminals 10 to 12 each implemented with the access control features designed to be implemented by the present invention.

In FIG. 2A, according to his business schedule, Taro HITACHI was, as indicated in a business schedule list 33 of FIG. 2B, scheduled to participate in a specification development meeting at Yokohama Building No. 3 on July 28. However, as Taro HITACHI unexpectedly ended up participating in a mobile regular meeting which was held was Yokohama Building No. 1 in an urgent manner, he was actually unable to modify his business schedule, thereby occurring an inconsistency between the business schedule and the location information of the terminal 10.

When Taro HITACHI made a request to activate a business application via the terminal 10, the access control designed to be implemented by the present invention is executed and makes a determination as to whether or not there is an inconsistency between Taro HITACHI's business schedule and the location information that was initially registered in the business schedule. As stated above, an inconsistency is occurred between Taro HITACHI's business schedule information and the location information. In a situation such as this, the present invention is designed to perform strict access control. Hereinafter, an outline of 3 exemplary embodiments of the present invention will be described.

As a first embodiment, when an inconsistency is occurred between a business schedule and location information, a management apparatus 2000, which assumes that the location information of the terminal that is near and the business affiliates are engaged in the same task as the target person, estimates the business context of Taro HITACHI by using the business schedule information of the employees who are business affiliates.

In FIG. 2A and FIG. 2B, the business schedule of Saburo HITACHI who participates in the same meeting on July 28 as Taro HITACHI and whose location information is near is regarded as the business schedule of Taro HITACHI. The location information in the business schedule will be used to estimate the business context. Then, by using the business context estimated by the management apparatus 2000, the terminal 10 acquires from an applied policy correspondence table 34 shown in FIG. 2B a policy to be applied to Taro HITACHI, and performs an access control on files in accordance with the policy.

As a second embodiment, when an inconsistency is occurred between a business schedule and location information, the management apparatus 2000 searches the location information history which resembles the variation pattern of the user's current location information, or the location information history of the people who are business affiliates. Then, the management apparatus 2000 estimates the business context corresponding to the history of the searched location information as the business context of the current user. According to FIG. 2A and FIG. 2B, Taro HITACHI is staying at Yokohama Building No. 1 for a fixed amount of time in order to participate in the mobile regular meeting. Past business context 31 of the business affiliate indicates Jiro HITACHI, a business affiliate of Taro, was also staying at Yokohama Building No. 1 to attend a meeting on July 21. The business context “within company” which was applied to Jiro HITACHI whose location information variation pattern resembles that of Taro HITACHI is estimated as the business context of Taro HITACHI for July 28.

Then, the terminal 10 of Taro HITACHI acquires from the applied policy correspondence table 34 the name of a policy to be applied to Taro HITACHI by using the estimated business context, and performs an access control on the terminal 10 in accordance with the name of the applied policy.

As a third embodiment, the management apparatus 2000 is, for each schedule of a user, stored with inconsistencies that have been occurred between the business schedule and the location information of the user, wherein the management apparatus 2000 estimates, when an inconsistency is occurred between the business schedule and the location information, the current business context based on the trend of the inconsistencies using the inconsistency history. In the same FIG. an inconsistency is occurred between the registered schedule and the location information of the user when the mobile regular meeting in which Taro HITACHI participated on July 28 is extended longer than scheduled. At this point, the management apparatus 2000 estimates the business context to be the same as the previous schedule and regards the current meeting is being extended since the inconsistency history indicates the same subject matter was extended on July 21. Then, the management apparatus 2000 acquires from the applied policy correspondence table a policy to be applied to the terminal 10 of Taro HITACHI based on the estimated business context, and performs an access control in accordance with the applied policy.

As described with 3 specific examples, the present invention is characterized in that, when it is determined the location information of the terminal 10 indicates differently from the location information according to the business schedule, it performs the access control which is provided with a location information-business schedule inconsistency resolution method designed to resolve inconsistencies between the location information of the terminal 10 and the business schedule information based on current business context of the business affiliate as well as past business context information and inconsistency history.

### Embodiment 1

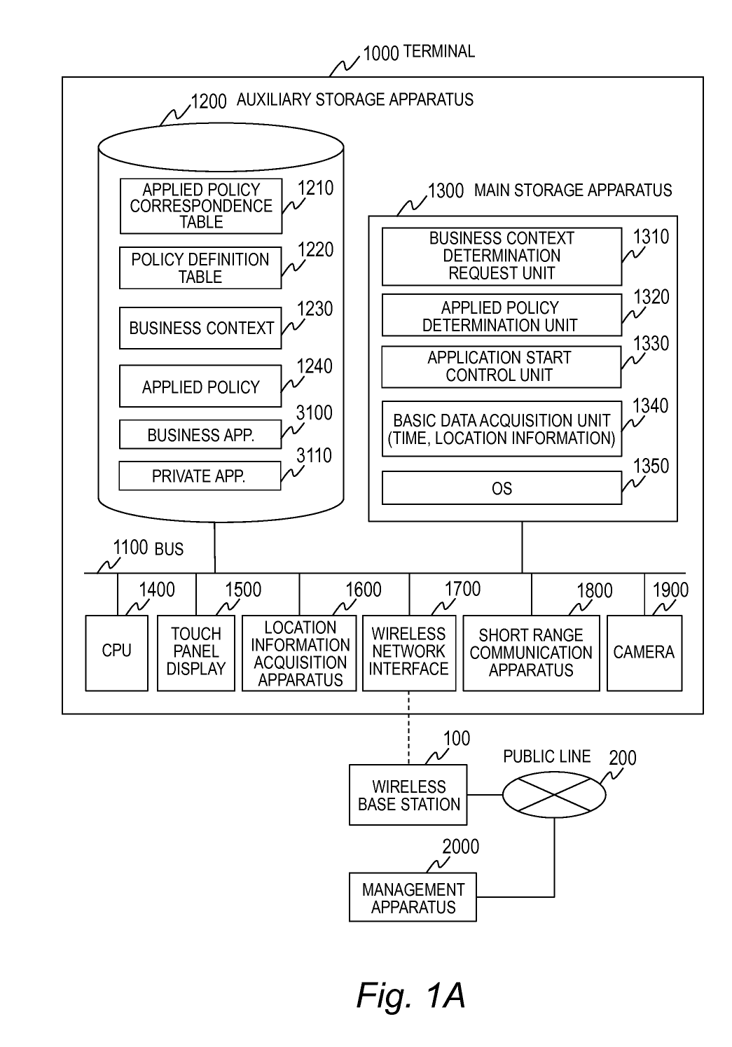

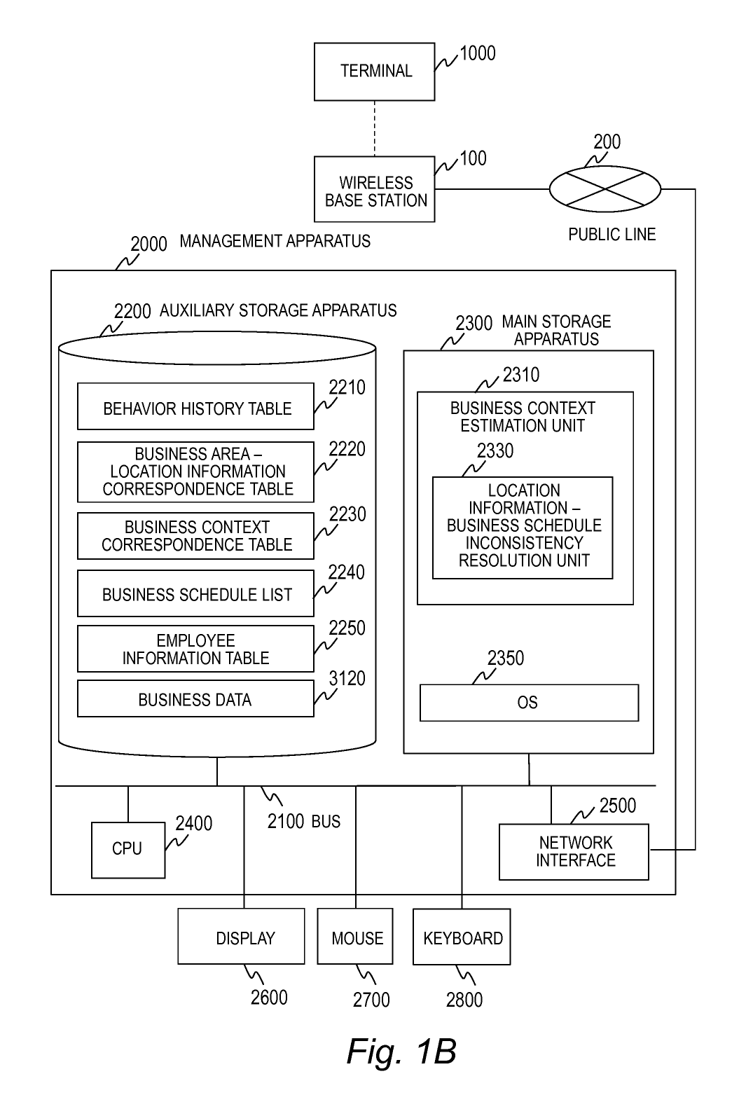

FIG. 1A and FIG. 1B each illustrate a configuration of an access control system for describing embodiment 1. FIG. 1A is a block diagram illustrating an example of a computer system to which the present invention is applied. FIG. 1B is a block diagram illustrating an example of a management apparatus configuring the access control system. The access control system includes the computer system which includes at least two terminals 1000, the management apparatus 2000, a wireless base station 100, and a public line (or the Internet) 200.

The terminal 1000, for example, includes a mobile terminal such as a smart phone or a tablet, which includes an auxiliary storage apparatus 1200, a main storage apparatus 1300, a CPU 1400, a touch panel display 1500, a location information acquisition apparatus 1600, such as a GPS, a wireless network interface 1700, a short range communication apparatus 1800, a camera 1900, and a bus (or the Internet) 1100 which collectively configure hardware thereof.

Note that when the wireless network interface 1700 is coupled with the public line 200, it goes through the wireless base station 100 to perform data communication.

The auxiliary storage apparatus 1200 includes an applied policy correspondence table 1210 designed to include therein policies to be applied in accordance with a business context, a business application 3100, a private application 3110, a business data 3120, a policy definition table 1220 designed to include therein the definitions of policies to be applied when granting access to each type of features included in terminals, a business context 1230 designed to store therein business context data, and an applied policy 1240 designed to store therein the names of applied policies. Further, the auxiliary storage apparatus 1200 includes therein a business application 3100 and a private application 3110 which will be loaded to the main storage apparatus 1300 when executing the applications. Note that the business application 3100 and the private application 3110 will be collectively referred to as applications.

The main storage apparatus 1300 includes a business context determination request unit 1310 designed to request the management apparatus 2000 to make a determination on business context, an applied policy determination unit 1320 designed to determine a policy to be applied based on business context, an application start control unit 1330 designed to perform start control of an application and access control of data in accordance with an applied policy, a basic data acquisition unit 1340 designed to acquire time information and location information, and an OS 1350 which is an underlying operating system to execute said process units, which are executed by a CPU 1400.

Note that each function unit of the business context determination request unit 1310, the applied policy determination unit 1320, the application start control unit 1330, and the basic data acquisition unit 1340 is loaded as program to the main storage apparatus 1300.

The CPU 1400 operates as a function unit designed to implement a predetermined function by operating in accordance with the program of each function. For example, 1400 operates as the basic data acquisition unit 1340 by operating in accordance with a basic data acquisition program. The CPU 1400 works the same way with other programs. Further, the CPU 1400 operates as a function unit designed to implement each of a plurality of processes operated by each program. The computer and the computer system include an apparatus and/or a system including these function units.

Note that information included in the program and/or the table for implementing each function unit may be stored at a storage device such as nonvolatile semiconductor memory, a hard disk drive, SSD (Solid State Drive), or the like, configuring the auxiliary storage apparatus 1200, or a computer readable non-temporary data storage medium such as an IC card, an SD card, a DVD, or the like.

In FIG. 1B, the management apparatus 2000, which may include, for example, a common business server, includes as hardware an auxiliary storage apparatus 2200, a main storage apparatus 2300, a CPU 2400, a network interface 2500, a display 2600, a mouse 2700, a keyboard 2800, and a bus 2100 which couples these apparatuses.

The auxiliary storage apparatus 2200 includes a behavior history table 2210 designed to record the behavior history of user, a business area-location information correspondence table 2220 which includes the correspondence between the names of the departments and location information described therein, a business context correspondence table 2230 which includes the context to be applied depending on the status of the users described therein, a business schedule list 2240 which records therein business schedule of the users, an employee information table 2250 which includes the attribute information of each employee such as an organization to which he or she belongs described therein, and business data 3120.

The main storage apparatus 2300 has loaded therein a business context estimation unit 2310 designed to estimate the business context of a user, a location information-business schedule inconsistency resolution unit 2330 designed to, when an inconsistency arises between a registered business schedule and the location information of a user, resolves the inconsistency and estimates a business context, and an OS 2350 which is an underlying operating system designed to execute these processes.

Note that each function unit of the business context estimation unit 2310, the location information-business schedule inconsistency resolution unit 2330, and the OS 2350 is loaded as program to the main storage apparatus 2300.

The CPU 2400 operates as a function unit designed to implement a predetermined function by operating in accordance with the program of each function. For example, the CPU 2400 operates as the business context estimation unit 2310 by operating in accordance with a business context estimation program. The CPU 2400 works the same way with other programs. Further, the CPU 2400 operates as a function unit designed to implement each of a plurality of processes operated by each program. The computer and the computer system include an apparatus and/or a system including these function units.

Note that information included in the program and/or the table for implementing each function unit may be stored at a storage device such as nonvolatile semiconductor memory, a hard disk drive, SSD (Solid State Drive), or the like, configuring the auxiliary storage apparatus 2200, or a computer readable non-temporary data storage medium such as an IC card, an SD card, a DVD, or the like.

An outline of the access control system according to the present embodiment will be described below with reference to FIG. 2B.

When a user of the terminal 1000 requests an application to start or to access the business data 3120 of the management apparatus 2000, the business context determination request unit 1310 which is loaded in the main storage apparatus 1300 inside the terminal 1000 will be executed. The business context determination request unit 1310 acquires date and time information and basic data which includes the location information of the terminal 1000 via the basic data acquisition unit 1340, and sends the acquired basic data to the business context determination request unit 1310. Note that the date and time information may be acquired from an NTP (Network Time Protocol) server, while the location information may be acquired from the location information acquisition apparatus 1600 which utilizes GPS (Global Positioning System).

The business context determination request unit 1310 after having received the basic data sends a request to the management apparatus 2000 to estimate the business context of the user having the terminal 1000. At this point, name information and the basic data of the owner of the terminal 1000 is transmitted to the management apparatus 2000.

The management apparatus 2000 after having received the request to estimate the business context from the terminal 1000 executes the business context estimation unit 2310.

The business context estimation unit 2310 receives from the terminal 1000 the name of an individual who made the request to estimate the business context, date, time and location information, and makes a determination as to whether there is an inconsistency between the location information designated in the business schedule list 33 which was registered in advance and the location information measured and acquired by the terminal 1000. The business context estimation unit 2310 estimates the business context based on the already registered schedule if there is no inconsistency based on the determination (S3). On the other hand, when there is an inconsistency between the current location information and the location information of the business schedule list, the business context estimation unit 2310 estimates the business context by using the location information-business schedule inconsistency resolution unit 2330, and transmits the estimated business context to the terminal 1000 (S1, S2).

The location information-business schedule inconsistency resolution unit 2330 estimates the business context by using the schedule information of the business affiliate when the location information of the user who requested the estimation of the business context is near.

The business context determination request unit 1310 of the terminal 1000 which has received the estimated business context from the management apparatus 2000 saves the estimation result at the business context 1230 at the auxiliary storage apparatus 1200.

The applied policy determination unit 1320 acquires from the applied policy correspondence table 1210 saved at the auxiliary storage apparatus 1200 a policy to be applied which corresponds to the business context 1230, and saves the policy at the applied policy 1240 at the auxiliary storage apparatus 1200.

The application start control unit 1330 acquires from the policy definition table 1220 a policy to be applied which corresponds to the applied policy 1240, and controls the start of the application and the access of the data in accordance with the acquired policy (S4).

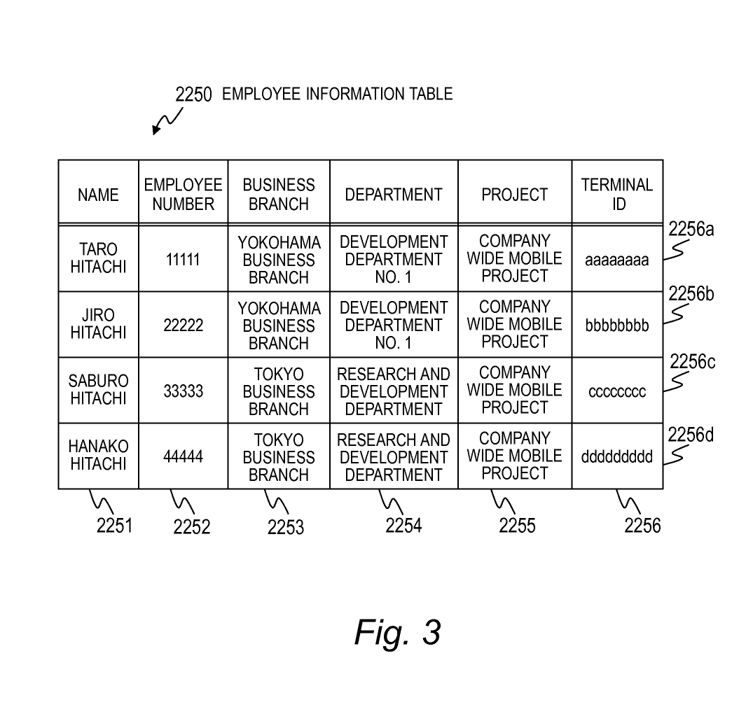

FIG. 3 illustrates an example of a data configuration of the employee information table 2250 used for embodiment 1. As illustrated in FIG. 3, employee information includes a name 2251 designed to store the name of an employee, an employee number 2252 designed to store an employee number of the employee, a business branch 2253 designed to store a business branch to which the employee belongs, a department 2254 designed to store a department to which the employee belongs, a PJ 2255 designed to store a project in which the employee currently is involved, and a terminal ID 2256 designed to uniquely identify the terminal 1000 that is loaned to a user.

The employee information table 2250 illustrated in FIG. 3 is used when searching for an employee who is affiliated with a particular user in the present embodiment. For example, a method to acquire an individual who is a business affiliate with Taro HITACHI 2251a in FIG. 3 includes search for a user matching any one of the business branch 2253, the department 2254, the project 2255, or the terminal ID 2256 of Taro HITACHI 2251a. According to FIG. 3, there are 2 individuals; “Jiro HITACHI” of a record 2255b and “Saburo HITACHI” 251c of a record 2255c, who includes at least one attribute matching with the business branch 2253, the department 2254, the project 2255, or the terminal ID 2256 of “Taro HITACHI” (2251) of the record 2255a.

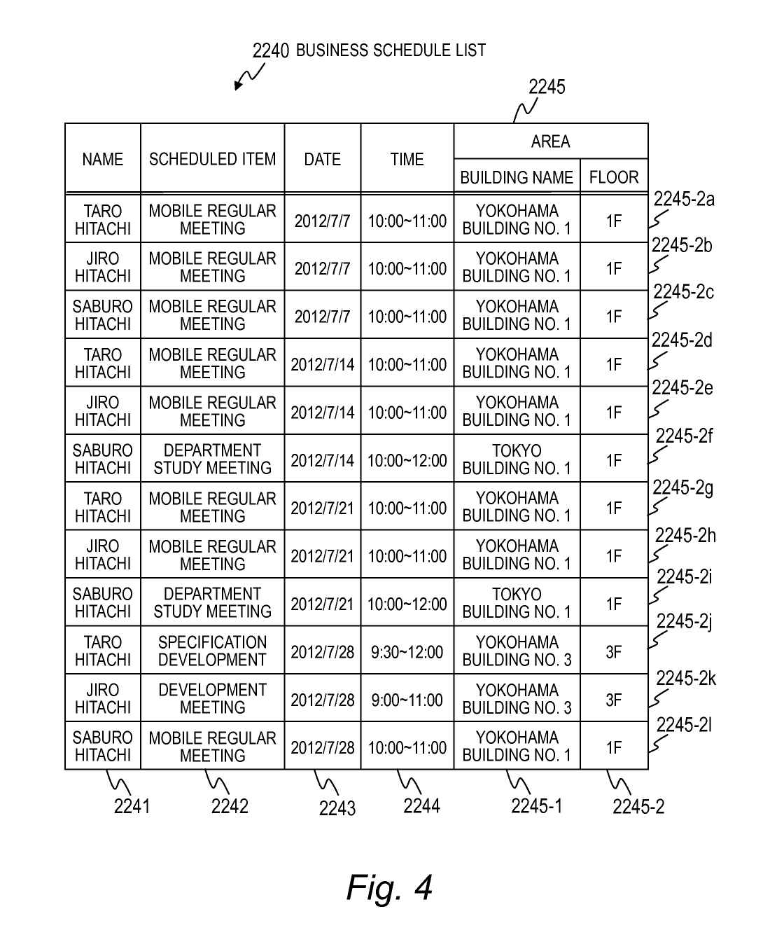

FIG. 4 is a diagram illustrating an example of a data configuration of the business schedule list 2240 used in embodiment 1. The business schedule list 2240 illustrated in FIG. 4 is used for purposes such as acquiring location information of a place at which a particular business is scheduled to take place corresponding to a user name and time.

As illustrated in FIG. 4, business schedule information includes a name 2241 designed to store a name of a registered user, a scheduled item 2242 designed to store a name of a scheduled business item, a date 2243 designed to store a date when the scheduled business item is executed, a time 2244 designed to store time at which the scheduled item is scheduled to start and time at which the scheduled item is scheduled to finish, and business area 2245 designed to store a place at which the scheduled item is to be executed.

The business area 2245 illustrated in FIG. 4 indicates information concerning the location at which the user conducts his/her business. According to the present embodiment, the business area 2245 includes both a building name 2245-1 designed to indicate the name of a building the business is conducted, and a floor 2245-2 designed to indicate the floor information. For example, according to the business schedule of Taro HITACHI of the record 2245-2a on Jul. 7, 2012 (2243) at 10 AM (2244), the business area (2245) at which the business is scheduled includes Yokohama Building No. 1 (2245-1) and 1F (2245-2).

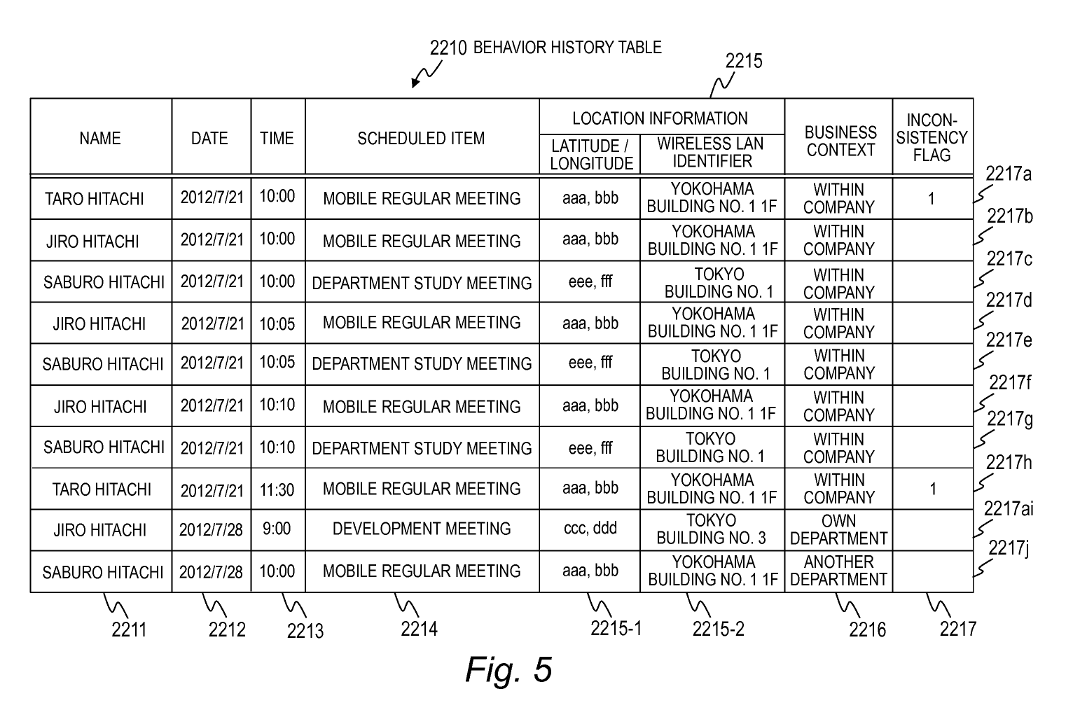

FIG. 5 is a diagram illustrating an example of a data configuration of the behavior history table 2210 used in embodiment 1. As illustrated in FIG. 5, the behavior history table 2210 includes a name 2211 designed to store the name of a user whose behavior is stored, a date 2212 designed to store the date when the behavior was taken, a time 2213 designed to store the time when the behavior was measured, a scheduled item 2214 designed to store the name of a scheduled item when the behavior was taken, a location information 2215 designed to store the location information that is measured when the behavior was taken, a business context 2216 designed to store the business context when the behavior was taken, and an inconsistency flag 2217 designed to store that an inconsistency was resolved by the location information-business schedule inconsistency resolution unit 2330.

Of the items indicated above, the location information 2215 may include both a latitude/longitude 2215-1 designed to store the meridian and parallels information and a wireless LAN identifier 2215-2 designed to store the unique identifier of a wireless LAN. However, the location information 2215 may only include a value of one of the latitude/longitude 2215-1 and the wireless LAN identifier 2215-2. Note that for the inconsistency flag 2217, “1” is stored for a record which was resolved by the location information-business schedule inconsistency resolution unit 2330, or otherwise the column is left blank.

The behavior history table 2210 illustrated in FIG. 5 is used in the present embodiment when making an acquisition regarding an individual whose location information indicates he or she is near the user at the same time. For example, according to FIG. 5, the management apparatus 2000 acquires “Jiro HITACHI” of a record 2217b as a user who was at the same place at the same time when a record 2217a indicates that Taro HITACHI (2211) was at aaa, bbb for latitude/longitude (2215-1), “Yokohama Building No. 1 at 1F” for the wireless LAN identifier (2215-2) at 10 o'clock (2213).

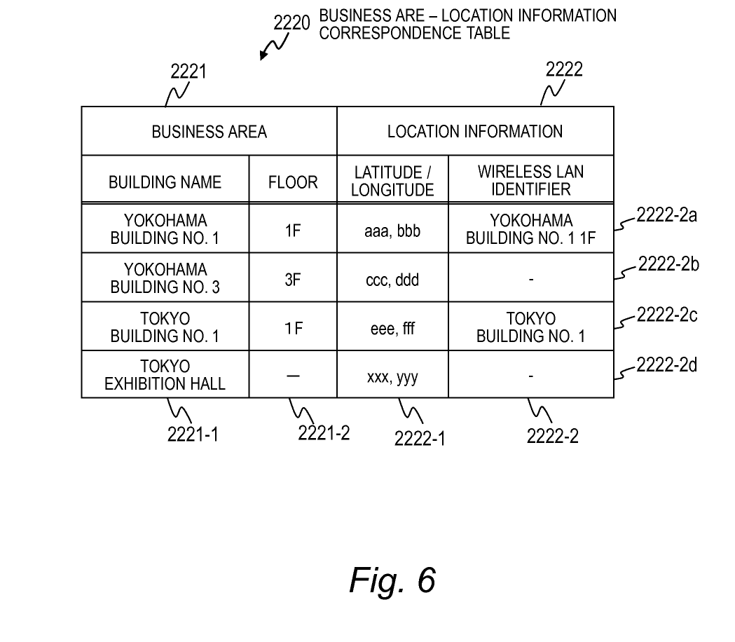

FIG. 6 is a diagram illustrating an example of a data configuration of the business area-location information correspondence table 2220 which is used to determine a business area where a user is based on the location information of the terminal 1000 in embodiment 1. As illustrated in FIG. 6, the business area-location information correspondence table 2220 includes a business area 2221 designed to store the information such as a name of the building at which a user conducts his/her business, and location information 2222 designed to store the location information such as geographical coordinates, or the like. Further, the business area-location information correspondence table 2220 is created by a system administrator and stored at the auxiliary storage apparatus 2200 at the management apparatus 2000.

The business area 2221 may include both the name of a company's building such as “Yokohama Building No. 1” as in a record 2221-2a, or the name of a building of an exhibition hall such as “Tokyo Exhibition Hall” as in a record 2221-2d and the information concerning the floor within the building. However, the business area 2221 may only include a value of one of the examples given above. Note that the location information 2222 includes the same information as that described with reference to FIG. 5. Also note that the business area 2221 includes a building name 2221-1 and a floor 2221-2, while the location information 2222 includes a latitude/longitude 2222-1 and a wireless LAN identifier 2222-2.

When a user is at “1F” (2221-2a) of “Yokohama Building No. 1” (2221-2a), it is determined that the location information includes “aaa, bbb” for the latitude/longitude 2222-1, and “Yokohama Building No. 1 1F” for the wireless LAN identifier 2222-2. Further, when the location information measured for the terminal 1000 includes “xxx, yyy” (2222-2d) for the latitude/longitude 2222-1, the management apparatus 2000 determines that the business area at which the user is Tokyo Exhibition Hall (2221-2d).

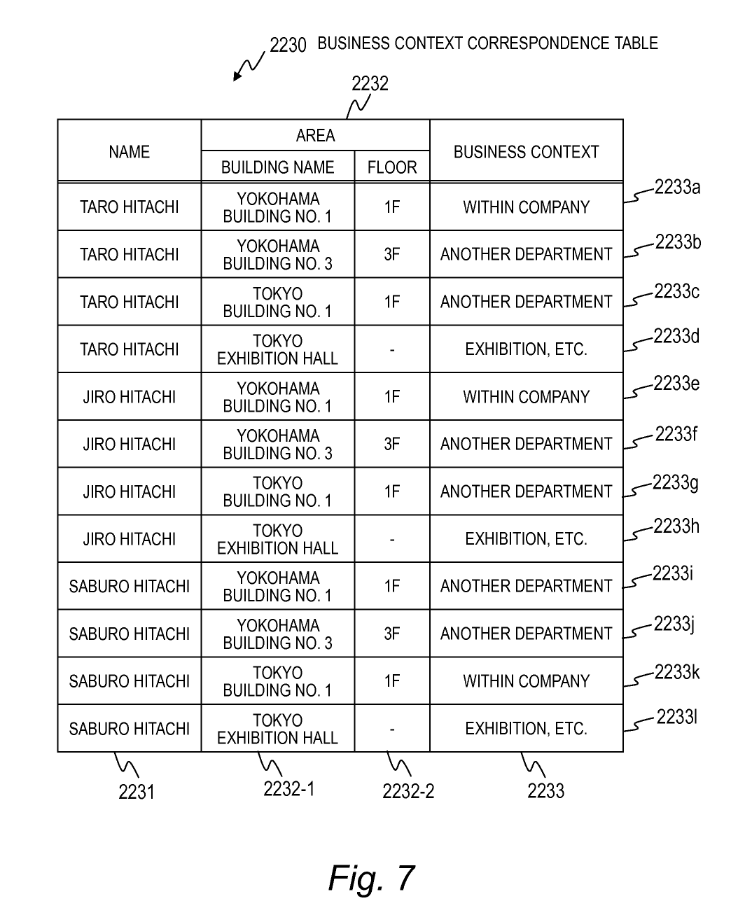

FIG. 7 is a diagram illustrating an example of a data configuration of the business context correspondence table 2230 which is used when estimating a business context from a user name and business area information. According to FIG. 7, there are occasions where even when a business area is identical, depending on users, business contexts may differ. As illustrated in FIG. 7, the business context correspondence table 2230 includes a name 2231 designed to store the name of a user to whom the business context is applied, a business are 2232 designed to store the name of a building and/or floor information, and a business context 2233 designed to store the name of an estimated business context. Further, the business context correspondence table 2230 is created by a system administrator, and stored at the auxiliary storage apparatus 2200 at the management apparatus 2000. Note that the business area 2232 includes a building name 2232-1 and a floor 2232-2.

The business area 2232 retains the information as that retained by the 2221 which is described with reference to FIG. 6. For example, when “Taro HITACHI” of a record 2233a is at the business area of “1F” (2232-2) of “Yokohama Building No. 1” (2232-1), the management apparatus 2000 estimates that the business context includes “within company” (2233).

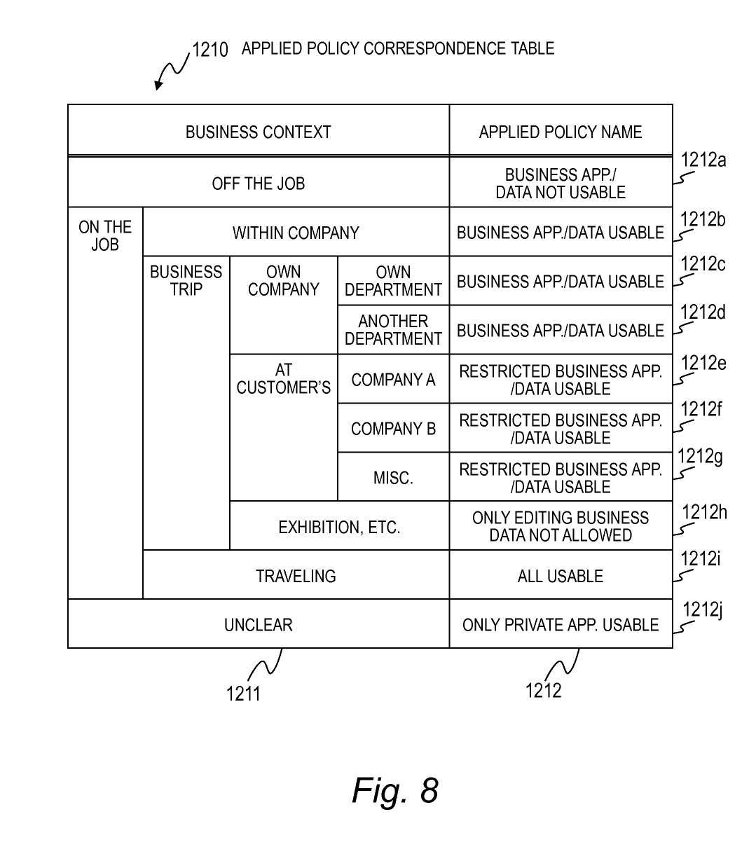

FIG. 8 is a diagram illustrating an example of a data configuration of the applied policy correspondence table 1210 used to determine a policy to be applied based on a business context according to embodiment 1. As illustrated in FIG. 8, the applied policy correspondence table 1210 includes a business context 1211 and an applied policy name 1212 corresponding thereto. Further, the applied policy correspondence table 1210 is created by a system administrator and is stored at the auxiliary storage apparatus 1200 at the terminal 1000 via a method such as a file transfer using a remote terminal management tool, an email attachment, or download from a web page by a user.

In the present embodiment, when the business context of a user includes “within company” (1212b), the name of a policy (1212) to be applied thereto includes “business app./data usable.”

In FIG. 8, when the business context 1211 includes “off the job,” the applied policy name 1212 includes “business app./data unusable” to prohibit the use of the business application 3100 and the business data 3120 on the terminal 1000.

Further, when the business context 1211 includes “on the job,” the applied policy name 1212 includes “business app./data usable” to permit the use of both the business application 3100 and the business data 3120 on the terminal 1000.

Further, when the business context 1211 includes “on the job, business trip, own company,” the applied policy name 1212 includes “business app./data usable” to permit the use of both the business application 3100 and the business data 3120 on the terminal 1000. On the other hand, when the business context 1211 includes “on the job, business trip, at customer's” the applied policy name 1212 includes “restricted business app./data usable” to permit the use of the business application 3100 and business data 3120 on the terminal 1000 when either of them was preset as permissible. Further, when the business context 1211 includes “on the job, business trip, exhibition, etc.,” the applied policy name 1212 includes “only editing business data not allowed” to prohibit editing the business data 3120 on the terminal 1000.

Further, when the business context 1211 includes “traveling,” the applied policy name 1212 includes “all usable” to permit the use of all the applications and data on the terminal 1000.

Further, when the business context 1211 includes “unclear,” the applied policy name 1212 includes “only private app. usable” to allow the use of the private application 3110 excluding the business application 3100 on the terminal 1000.

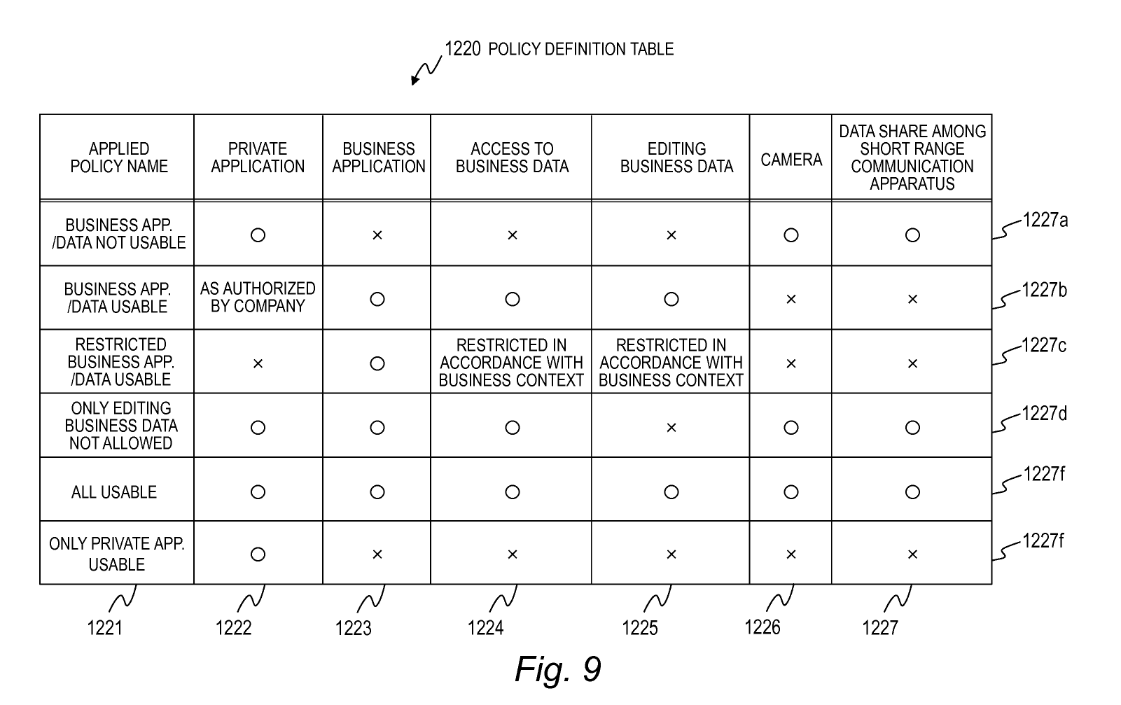

FIG. 9 is a diagram illustrating an example of a data configuration of the policy definition table 1220 which defines the details concerning the access control corresponding to each policy name. As illustrated in FIG. 9, the policy definition table 1220 includes an applied policy name 1221, a private application 1222, a business application 1223, an access to business data 1224, an editing business data 1225, a camera 1226, and a data share among short range communication apparatus 1227 designed to be applied to a user. Further, the policy definition table 1220 is created by a system administrator similarly as the applied policy correspondence table 1210 in FIG. 8, and stored at the auxiliary storage apparatus 1200 at the terminal 1000 via a method described above.

In the present embodiment, when the applied policy name 1221 includes “business app./data usable” (record 1227b), an access control: as for the private application 1222 only the application permitted by the company becomes enabled, the business application 1223 becomes enabled; and the access to business data 1224 also becomes enabled; the editing business data 1225 becomes enabled, the camera 1226 is set as unusable; and the data share among short range communication apparatus 1227 such as IrDA or Bluetooth (Bluetooth is a registered trademark, hereinafter, referred to as Bluetooth) is set as unusable, will be performed.

Further, access control may include, aside from the setting indicated above, a setting on URLs wherein access to a browser, or the like, is permitted or prohibited per each applicable policy, or a setting on port numbers where some access are permitted while others are prohibited.

Note while the camera 1900 and the short range communication apparatus 1800 are given as example of devices, the use of which is restricted by the application start control unit 1330 in accordance with the applied policy name, the present invention is not limited to such devices, and may include a voice recorder/reproducing apparatus, a communication apparatus, or the like.

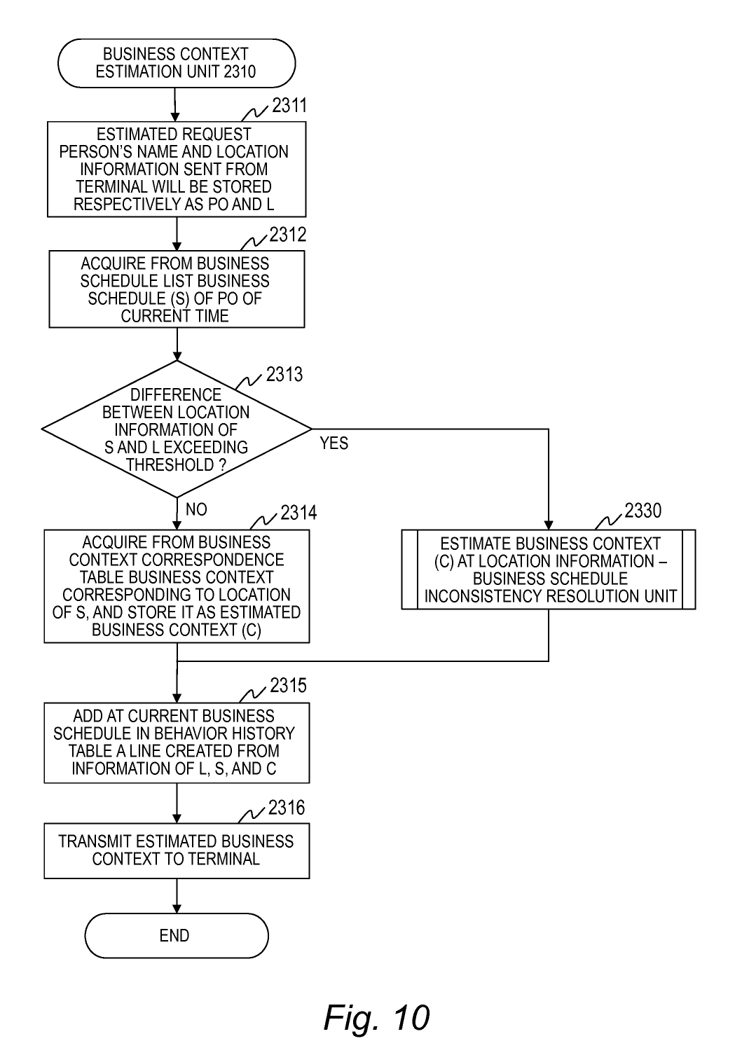

Next, with the flowchart illustrated in FIG. 10, an example of a process performed by the business context estimation unit 2310 of the management apparatus 2000 will be described. The business context estimation unit 2310 estimates a business context (or a business status) of a user.

The business context estimation unit 2310 is executed when a request to estimate a business context is received from the business context determination request unit 1310 of the terminal 1000. Further, at the same time as when the request is received, the name of owner of the terminal, data information, and the location information of the terminal 1000 is transmitted from the terminal 1000.

When the business context estimation unit 2310 is executed, the information initially received from the terminal 1000 is stored, wherein the owner of the terminal is stored as a variable P0 and the location information is stored as a variable L at Step 2311.

At Step 2312, the business context estimation unit 2310 acquires the business schedule at the current time of the variable P0 from the business schedule list 2240 and stores it as a variable S.

The business context estimation unit 2310 acquires the location information 2222 corresponding to the business area 2221 of the variable S from the business area-location information correspondence table 2220. The business context estimation unit 2310 compares the acquired location information 2222 with the variable L, and determines, when, for example, the longitude and latitude information between the two in a straight line are within a predetermined value (e.g., 10 m), or the two share the identical wireless LAN identifier, that there is no inconsistency between the business schedule that was registered and the location information that was measured by the terminal 1000, or, when said conditions are not satisfied, that there is an inconsistency therebetween.

When there is an inconsistency between the business schedule and the location information measured by the terminal 1000, the business context estimation unit 2310 passes the process to the location information-business schedule inconsistency resolution unit 2330, awaits an estimated business context resolving the inconsistency to be returned, and stores the returned estimated business context as a variable C.

When there is no inconsistency between the business schedule and the location information measured by the terminal 1000, the business context estimation unit 2310 proceeds to Step 2314, acquires a business context corresponding to the location of the variable S from the business context correspondence table 2230, and stores the estimated business context as the variable C.

At Step 2315, the business context estimation unit 2310 adds the variable P0, the date, the time, and the variable L received from the terminal 1000, the variable S acquired from the management apparatus 2000, and the information concerning the variable C estimated by the location information-business schedule inconsistency resolution unit 2330 at the behavior history table 2210.

At Step 2316, the business context estimation unit 2310 transmits the variable C, which is the estimated business context, to the terminal 1000, and ends the execution of the business context estimation unit 2310.

A process of estimating a business context of a user as executed by the business context estimation unit 2310 will be described with an example.

For example, as illustrated in FIG. 2A, when Taro HITACHI activates the business application 3100 at 1F of Yokohama Building No. 1 at 10 AM on July 28, his terminal transmits a request to estimate the business context which includes owner name: Taro HITACHI, current time: 10 AM on July 28, longitude/latitude as the location information: aaa, bbb, and wireless LAN identifier: 1F at Yokohama Building No. 1 to the management apparatus 2000.

The management apparatus 2000, having received the request to estimate the business context, executes the business context estimation unit 2310, stores as the variable P0 Taro HITACHI as the name of the terminal owner transmitted from the terminal 1000 during S2311 in FIG. 10, and stores as the variable L the location information of the terminal (longitude/latitude: aaa, bbb, and wireless LAN identifier: 1F at Yokohama Building No. 1).

At Step 2312, the business context estimation unit 2310 acquires from the business schedule list 2240 the business schedule (record 2245-2j) of the variable P0 that is scheduled for the current time (10 AM on July 28), and stores the same as the variable S.

At Step 2313, as the business context estimation unit 2310 makes a comparison between the business area information registered at the variable S and the variable L where the location information of the terminal 1000 is stored, the business context estimation unit 2310 converts the location information stored at the variable L into business area information by using the business area-location information correspondence table 2220. Since the longitude/latitude: aaa, bbb currently stored at the variable L corresponds to 2222-1a and the wireless LAN identifier: 1F at Yokohama Building No. 1 corresponds to 2222-2a, the business area of the variable L is converted to include building name: Yokohama Building No. 1, and floor: 1F.

Since the business area registered at the variable S does not correspond to the business area of the variable L for neither the building name nor the floor, the determination at Step 2313 includes that a threshold is exceeded, and the process proceeds to Step 2330. Note that the threshold herein is set as, for example, 10 m or 50 m, or the like, and that when the difference between the location information corresponding to the business area information registered at the variable S and the location information of the terminal 1000 is within the threshold, it is regarded that the terminal 1000 is according to the schedule. Note that the above stated threshold may be set so as to determine, other than the difference in the location information, that an identical wireless LAN identifier is regarded as within the threshold. Alternatively, the threshold may be set so as to determine that when the location information corresponding to the business area information which is registered at the variable S is within a predetermined range (e.g., 10 m or 50 m, or the like) it is within the same business area.

At the location information-business schedule inconsistency resolution unit 2330, the business context that resolves the inconsistency regarding the location information and the business schedule is estimated to be “within company,” and the estimated business context “within company” is stored as the variable C. At this point, to resolve the inconsistency, the variable S designed to store the business schedule is modified by the location information-business schedule inconsistency resolution unit 2330 to include “mobile regular meeting” for the scheduled item, “10:00 to 11:00” for the time, “Yokohama Building No. 1” for the name of the building of the business area, and “1F” for the floor of the same. Note that a process to estimate business contexts and a process to change business schedules by the location information-business schedule inconsistency resolution unit 2330 will be described below in detail.

Further, when it is determined in Step 2313 that the difference in the location information is within the threshold, the process proceeds to Step 2314, wherein by using the business context correspondence table 2230 the business context corresponding to the business area information stored at the variable P0 and the variable S is acquired and the acquired business context is stored at the variable C.

At Step 2315, the variable P0 which stores the name, Taro HITACHI, who requested the estimation of the business context, the scheduled item “mobile regular meeting” of the variable S which stores the current date, July 28, time, 10 AM, and the current business schedule, the variable L which stores the current location information “longitude/latitude: aaa, bbb, and wireless LAN identifier: 1F at Yokohama Building No. 1,” and the information of the business context “within company” and the inconsistency flag “1” are added to the behavior history table 2210.

Finally, at Step 2316, the business context estimation unit 2310 transmits the estimated business context “within company” to the terminal 1000, and ends the process.

As described above, the business context estimation unit 2310 estimates the business context of the user based on the business context of the user's business affiliate by using the location information received from the terminal 1000 an the location information stored by the management apparatus 2000, and transmits the estimated business context to the terminal 1000.

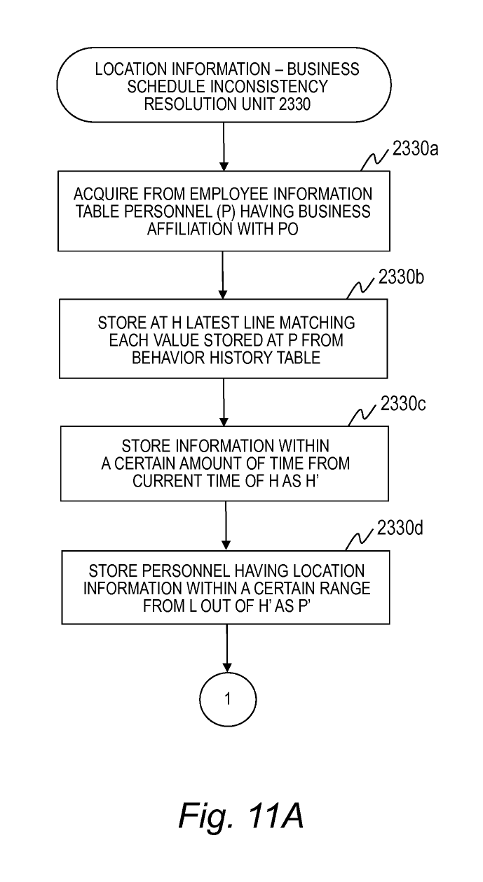

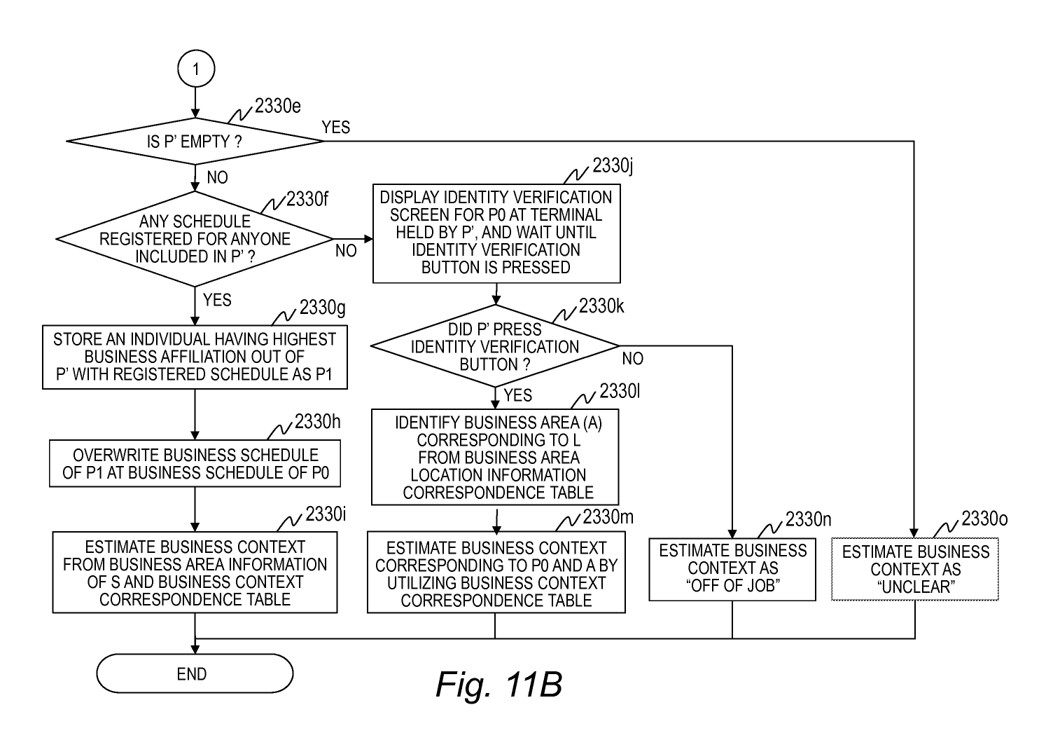

Next, with reference to the flowcharts illustrated in FIG. 11A and FIG. 11B, the flow of the process executed by the location information-business schedule inconsistency resolution unit 2330 will be described. Note that FIG. 11A illustrates a first half of a flowchart illustrating an example of a process executed by the location information-business schedule inconsistency resolution unit 2330, while FIG. 11B illustrates a latter half of the flowchart illustrating the example of the process executed by the location information-business schedule inconsistency resolution unit 2330.

The location information-business schedule inconsistency resolution unit 2330 includes a process that is executed when Step 2313 by the business context estimation unit 2310 determines that there is an inconsistency between the business area information of the variable S and the variable L, and that is executed in order to resolve the inconsistency by using the business schedule information of the work affiliated person who is near the user.

Initially, at Step 2330a, the location information-business schedule inconsistency resolution unit 2330 acquires from the employee information table 2250 the variable P0 and a person who is a work affiliate, and stores the acquired set at a variable P.

What is meant by the business affiliate according to the present invention includes an individual who includes, according to the employee information table 2250, out of the business branch 2253, the department 2254, and the project 2255 at least one matching information with the user.

At 2330b, a latest line matching each value in which the name 2211 from the behavior history table 2210 is stored at the variable P is stored at a variable H.

At 2330c, information within a certain amount of time, for example, within 15 minutes, from the current time of the variable H is stored at variable H′.

At 2330d, out of the variable H′, name information of an individual who satisfies that he/she is within a certain distance from L, for example, the distance is within 10 m or 50 m, or his/her wireless LAN identifier information is identical is stored at a variable P′.

At 2330e, the location information-business schedule inconsistency resolution unit 2330 makes a determination as to whether or not the variable P′ is empty. When it is empty, the process proceeds to Step 2330m, and when it is not empty, the process proceeds to Step 2330d.

At 2330f, the location information-business schedule inconsistency resolution unit 2330 makes a determination as to whether or not at least one individual out of the variable P′ has his/her business schedule registered. When not one out of the variable P′ has his/her business schedule registered, the process proceeds to Step 2330j, and when at least one individual out of the variable P′ has his/her schedule registered, the process proceeds to Step 2330g.

At step 2330g, the location information-business schedule inconsistency resolution unit 2330 determines an individual with the highest degree of business affiliation out of the variable P′ with the registered schedule, and stores the determined content at a variable P1. Here, the degree of business affiliation is determined by the number of matching criteria out of the information, for example, of business branch, department, and project of the variable P0 and the variable P′. It is to be noted, though, that the calculation method of the degree of business affiliation is not limited to that which is described above. For example, a method such as assigning a grade to each piece of information or using other sources of information such as the year an individual joined the company may be used.

At Step 2330h, the location information-business schedule inconsistency resolution unit 2330 overwrites the business schedule of current time registered at the variable P1 on the variable S at which the business schedule P0 is currently conducting is stored.

At Step 2330i, the location information-business schedule inconsistency resolution unit 2330 acquires from the business context correspondence table 2230 the business context which corresponds to the business area information registered at the variable P0 and the variable S, and estimates the acquired business context as the current business context of the variable P0. At this point, said business context is stored at the variable C.

At Step 2330f, an identity verification screen of the variable P0 is displayed at the terminal 1000 held by the variable P′ at Step 2330j which is a process that is executed when no one at the variable P′ has business schedule registered, and waits until any one of the variable P′ presses a button on the identity verification screen. At Step 2330j showing an example of the present embodiment, an alternative method to display the variable P0 is identical as the user of the terminal such as a personal authentication method using a short range communication apparatus such as NFC or Bluetooth may suffice.

At Step 2330k, the location information-business schedule inconsistency resolution unit 2330 makes a determination as to whether or not the variable P′ pressed the button to verify himself/herself. When the button to verify himself/herself is not yet pressed, the process proceeds to Step 2330n, and when the button to verify himself/herself is pressed, the process proceeds to Step 2330l.

At Step 2330l, the location information-business schedule inconsistency resolution unit 2330 acquires from the business area-location information correspondence table 2220 the business area corresponding to the variable L, and stores the acquired business area information at a variable A. For example, when the location information stored at the variable L includes eee, fff for the latitude/longitude, and Tokyo Building No. 1 for the wireless LAN identifier, since the wireless LAN identifier information corresponds to 2222-2c, the acquired business area information includes Tokyo Building No. 1 for the building name 2221-1 and 1F for the floor 2221-2.

At Step 2330m, the location information-business schedule inconsistency resolution unit 2330 acquires from 2230 the business context corresponding to the variable P0 and the variable A. For example, when the variable P0 includes Taro HITACHI, and the variable A includes Tokyo Building No. 1 for the building name information and 1F for the floor information, the variable P0 matches with the names 2231 of the records 2233a to 2233d, while the variable A matches with the building name 2232-1 of the record 2233c according to the business context correspondence table 2230 illustrated in FIG. 7. Therefore, the business context to be extracted includes “another department” (record 2233c).

At Step 2330n, the location information-business schedule inconsistency resolution unit 2330 stores “off the job” at the variable C which stores therein estimated business contexts.

At Step 2330o, the location information-business schedule inconsistency resolution unit 2330 stores “unclear” at the variable C which stores therein estimated business contexts.

The process for the location information-business schedule inconsistency resolution unit 2330 to resolve an inconsistency and estimate a business context when an inconsistency arises between the location information of a user and his/her business schedule will be described with a reference to an example.

The description will be made based on an assumption, as illustrated in FIG. 2A, that Taro HITACHI activated the business application 3100 at 1F of Yokohama Building No. 1 at 10 AM on July 28. Therefore, it is assumed that before the execution of the location information-business schedule inconsistency resolution unit 2330 Taro HITACHI is stored at the variable P0 which stores user names, longitude/latitude: aaa, bbb, and wireless LAN identifier: 1F at Yokohama Building No. 1 is stored at the variable L which stores the location information of the user, the records 2245-2j of the business schedule list 2240 illustrated in FIG. 4 is stored at the variable S which stores business schedule of user.

When it is determined in Step 2313 of FIG. 10 that the difference between the business area information of the variable S and the location information of the variable L exceeds the threshold, the location information-business schedule inconsistency resolution unit 2330 illustrated in FIG. 11 is executed.

At Step 2330a, the location information-business schedule inconsistency resolution unit 2330 acquires from the employee information table 2250 the record 2255a which includes “Yokohama Business Branch” for the business branch 2253, “Development Department No. 1” for the department 2254, and “Company Wide Mobile Project” for the project 2255 for “Taro HITACHI” stored at the variable P0. Next, the location information-business schedule inconsistency resolution unit 2330 acquires from the employee information table 2250 an individual whose information matches with at least any one of the business branch, department, or the project, and stores it at the variable P. At this point, Jiro HITACHI (record 2255b) whose business branch, department, and project match with those of Taro's, and Saburo HITACHI (record 2255c) whose project matches with that of Taro's will be stored at the variable P.

At Step 2230b, the location information-business schedule inconsistency resolution unit 2330 stores out of the behavior history table 2210 in FIG. 5 a latest line matching with “Jiro HITACHI” whose name 2211 is stored at the variable P and a latest line matching with “Saburo HITACHI” are stored at the variable H. Note that the lines that are actually extracted from the behavior history table 2210 illustrated in FIG. 5 and stored at the variable H include 2217i, which is the latest line matching with “Jiro HITACHI” and 2217j, which is the latest line matching with “Saburi HITACHI.”

At Step 2330c, the location information-business schedule inconsistency resolution unit 2330 acquires out of the information stored at the variable H information that is within 15 minutes from 10 AM, which is the current time, and stores the same at the variable H′. In this case, since the information of Jiro HITACHI (record 2217i), which was registered at 9 AM, does not qualify: only the information of Saburo HITACHI (record 2217j) will be stored at the variable H′.

At Step 2330d initially, the location information-business schedule inconsistency resolution unit 2330 makes a comparison between the location information retained by the variable H′ and the variable L. The location information retained by the variable H′ includes aaa, bbb for the latitude/longitude 2215-1 and 1F at Yokohama Building No. 1 for the wireless LAN identifier. From this, since the location information retained by the variable H′ matches with the variable L, the location information-business schedule inconsistency resolution unit 2330 determines that an individual who is near the variable L to be Saburo HITACHI, and stores Saburo HITACHI at the variable P′.

At Step 2330e, the location information-business schedule inconsistency resolution unit 2330 makes a determination as to whether or not the variable P′ is empty. Since Saburo HITACHI is stored at the variable P′ currently, 2330f will be executed as a next step.

At Step 2330f, the location information-business schedule inconsistency resolution unit 2330 makes a determination as to whether or not a business schedule is registered for the user who is stored at the variable P′ at the current time. Based on the business schedule list 2240 illustrated in FIG. 4, the location information-business schedule inconsistency resolution unit 2330 acquires the business schedule that matches name: Saburo HITACHI, date: Jul. 28, 2012, and time: 10 AM. When there is no matching information at this point, Step 2330j will be executed next, however, since the record 2245-21 of FIG. 4 matches at this point, Step 2330g will be executed next.

At Step 2330g, the location information-business schedule inconsistency resolution unit 2330 acquires from the variable P′ in which business schedule of the current time is registered an individual having the highest degree of business affiliation, and stores the same at the variable P1. The degree of business affiliation according to the present embodiment is determined by the number of match between the information of the variable P0 and the information of the variable P′ concerning the business branch, the department, and the project, therefore, the degree of business affiliation of all the members registered at the variable P′ will be calculated. Since only Saburo HITACHI is stored at the variable P′ currently, the degree of business affiliation of Saburo HITACHI will be calculated. Since only the project of Saburo HITACHI matches, the degree of his business affiliation is determined as “1.” Further, since only one user is stored at the variable P′, according to the present example, the individual having the highest degree of business affiliation includes Saburo HITACHI, and therefore, Saburo HITACHI will be stored at the variable P1 at which an individual having the highest business affiliation is stored.

At Step 2330h, the location information-business schedule inconsistency resolution unit 2330 acquires from the business schedule list the current business schedule of Saburo HITACHI stored at the variable P1, and stores the business schedule of the variable P1 at the variable S which stores the user's business schedule. The process of a method to acquire the current business schedule of the variable P1 is the same as that executed at Step 2330f, and therefore is omitted here. The acquired business schedule information includes the record 2245-2k in FIG. 4, and it will be stored at the variable S.

At Step 2330i, the location information-business schedule inconsistency resolution unit 2330 acquires from the business context correspondence table 2230 illustrated in FIG. 7 a business context corresponding to the business area information stored at the variable S. Since the business area stored currently at the variable S includes 2245-2k of the business schedule list 2240, building name: Yokohama Building No. 1, and floor: 1F is stored. Since it is determined according to the business context correspondence table 2230 illustrated in FIG. 7 that the business context corresponding to Taro HITACHI stored at the variable P0 and above stated business area include within company (record 2233a), the estimated business context of the variable P0 includes “within company.”

The location information-business schedule inconsistency resolution unit 2330 estimates the business context from the above stated steps (2330g, or any one of 2330k, 2330l, 2330m), and resolves the inconsistency occurred between the business area information of the business schedule registered for the user and the location information of the terminal.

As described above, according to the present embodiment an inconsistency occurred between a business schedule and the location information of a terminal is resolved when a business affiliate is near the user who resolves the inconsistency so as to make it possible to perform strict access control without impairing the convenience for the user.

That is, it becomes possible to resolve the inconsistency occurred between the location information measured by the terminal retained by the user and registered schedule information by estimating a business context based on the business schedule information, wherein the business schedule registered under an individual who is a business affiliate with the user and who owns the terminal 1000 whose location information is near the terminal 1000 owned by the user is regarded as the business schedule of the user.

Note that while the example in which the business context is estimated by the management apparatus 2000 was described for the above described first embodiment, the management apparatus 2000 may decide the policy to be applied based on the estimated business context, and notify the applied policy to the terminal 1000.

### Embodiment 2

While embodiment 1 is an effective access control method when a business affiliate is near at the same time (difference between location information within a threshold, wireless LAN identifier identical), a present embodiment will be described with an example utilizing the past behavior of a business affiliate so as to implement access control without impairing the convenience of the user.

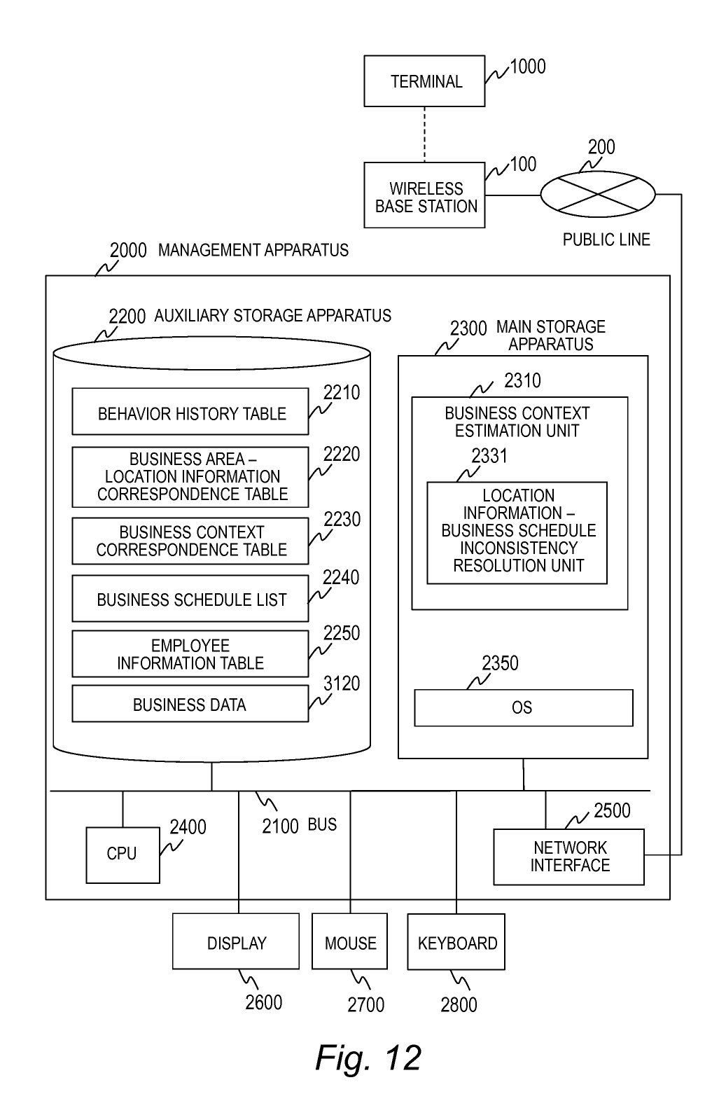

A configuration of an access control system exemplifying the present embodiment is illustrated in FIG. 12.

FIG. 12 illustrates similarly to the system configuration of embodiment 1 of FIG. 1, however, the difference in the system configuration of FIG. 12 from that in FIG. 1 is a location information-business schedule inconsistency resolution unit 2331 which is loaded in the main storage apparatus 2300 at the management apparatus 2000. The location information-business schedule inconsistency resolution unit 2331 processes differently from the location information-business schedule inconsistency resolution unit 2330 illustrated in FIG. 1. Other aspects of the system configuration are the same as those in the above described embodiment 1.

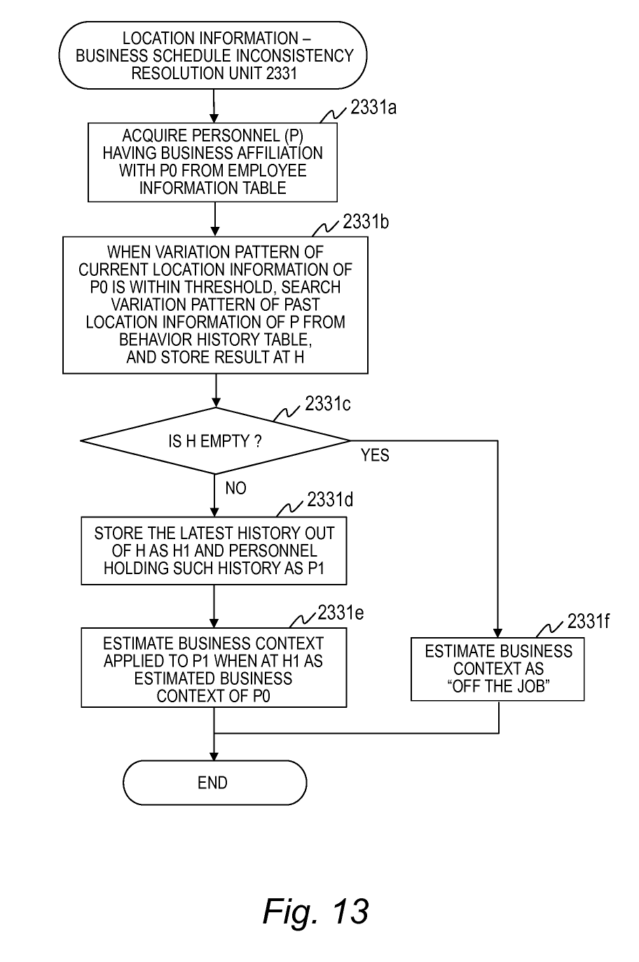

With reference to a flowchart illustrated in FIG. 13, the flow of the process executed by the location information-business schedule inconsistency resolution unit 2331 will be described.

The location information-business schedule inconsistency resolution unit 2331 includes a process which is executed when it is determined in Step 2313 by the business context estimation unit 2310 that an inconsistency is occurred the business area information of the variable S and the variable L, and includes a process which is executed in order to resolve the inconsistency by utilizing behavior history information of a business affiliate who is near a user.

When the location information-business schedule inconsistency resolution unit 2331 is called, Step 2331a is executed first.

At Step 2331a, the location information-business schedule inconsistency resolution unit 2331 acquires from the employee information table 2250 the name information of a business affiliate of a user name, and stores the same at the variable P. What is meant by the business affiliate includes, in the same manner as in embodiment 1, a user whose business branch, department, and project matches.

At Step 2331b, the location information-business schedule inconsistency resolution unit 2331 searches the behavior history table 2210 for a variation pattern of the past location information of the user stored at the variable P resembling the current variation pattern of the location information of the user. Then, the behavior history information having a similar variation pattern of location information is stored at the variable H. A method to search for location information having a similar variation pattern according to the present embodiment includes, for example, searching for a user having a variation pattern identical with the location information of the three most recent variation patterns.

At Step 2331c, the location information-business schedule inconsistency resolution unit 2331 makes a determination as to whether or not the variable H is empty. When it is empty, the process proceeds to Step 2331f, when it is not empty, the process proceeds to Step 2331d.

When the variable H is not empty and when the process proceeds to Step 2331d, the most recent history out of the variable H is stored at the variable H1, and the name of the user who took the behavior of the variable H1 is stored at the variable P1.

At Step 2331e, the location information-business schedule inconsistency resolution unit 2331 estimates the business context applied to the variable P1 during the variable H1 to be the business context of the variable P0, and stores the estimated business context at the variable C.

When the variable H is empty and when the location information-business schedule inconsistency resolution unit 2331 proceeds to Step 2331f, the business context is estimated to include “off the job,” and the “off the job” is stored at the variable C where estimated business contexts are stored.

The process for the location information-business schedule inconsistency resolution unit 2331, which executes the process as described above, to, when an inconsistency is occurred between the location information of the user and the business schedule, resolve the inconsistency and to estimate the business context will be described with reference to an example.

The description will be made based on an assumption that Taro HITACHI who is at 1F of Yokohama Building No. 1 starting at 9:50 AM on July 28 activated the business application 3100 at 10 AM. Therefore, it is assumed that before the location information-business schedule inconsistency resolution unit 2331 is executed, the variable P0 which stores user names stores Taro HITACHI, the variable L which stores the location information of the user stores the latitude/longitude: aaa, bbb, and the wireless LAN identifier: 1F at Yokohama Building No. 1, and the variable S which stores the business schedule of the user stores the record 2245-2j inside the business schedule list 2240 illustrated in FIG. 4.

When it is determined at Step 2313 of FIG. 10 that the difference between the business area information of the variable S and the location information of the variable L exceeds the threshold, the location information-business schedule inconsistency resolution unit 2331 illustrated in FIG. 11 will be executed.

When the location information-business schedule inconsistency resolution unit 2331 is called, Step 2331a is executed first.

At Step 2331a, the location information-business schedule inconsistency resolution unit 2331 acquires from the employee information table 2250 “Yokohama Business Branch” for the business branch 2253, “Development Department No. 1” for the department 2254, and “Company Wide Mobile” for the project 2255 all of which correspond to “Taro HITACHI” stored at the P0. Next, the location information-business schedule inconsistency resolution unit 2331 acquires from the employee information table 2250 an individual having at least one match with the acquired business branch, department, or project, and stores the same at the variable P. At this point, Jiro HITACHI (record 2255b) whose record matches with the business branch, the department, and the project, and Saburo HITACHI (record 2255c) whose project matches will be stored at the variable P.

At Step 2331b, the location information-business schedule inconsistency resolution unit 2331 acquires out of the behavior history table 2210 a pattern that resembles the current variation pattern of the location information of the user. The variation pattern of the location information of the user includes the latitude/longitude: aaa, bbb, and the wireless LAN identifier: 1F at Yokohama Building No. 1, which were measured three consecutive times at 9:50, 9:55, and 10:00 AM. According to the behavior history table 2210 illustrated in FIG. 5, only 2217b, 2217d, and 2217f of Jiro HITACHI were measured three consecutive times for the latitude/longitude: aaa, bbb, and the wireless LAN identifier: 1F at Yokohama Building No. 1. Therefore, the behavior histories of the records 2217b, 2217d, and 2217f will be stored at the variable H as the behavior history resembling the user's behavior pattern.

At Step 2331c, it is determined whether or not the variable H is empty. According to the present example, since the behavior histories of Jiro HITACHI are stored at the variable H, it is determined that the variable H is not empty and the process proceeds to Step 2331d.

At Step 2331d, the location information-business schedule inconsistency resolution unit 2331 stores the most recent history out of the behavior histories stored at the variable H as a variable H1, and stores the name of the user who took the behavior stored at the variable H1 at the variable P1. Note that since only one piece of information is, according to the present example, stored at the variable H, the values of the records 2217b, 2217d, and 2217f out of the behavior history table 2210 illustrated in FIG. 5 will be stored at the H1, while Jiro HITACHI who took the behavior of the variable H1 is stored at the variable P1.

At Step 2331e, the location information-business schedule inconsistency resolution unit 2331 estimates the business context applied to Jiro HITACHI stored at the variable P1 when he took the behavior stored at the variable H1 as the business context of the variable P0. Since the business context stored at the variable H1 according to the present example includes “within company” (record 2217f), the business context of the variable P0 is estimated as “within company” and “within company” is stored at the variable C which stores estimated business contexts.

As described above, according to the present embodiment, an inconsistency occurred between a business schedule list 2240 and the location information of a terminal is resolved by utilizing the information of a business affiliate having a behavior history who resembles the user wishing to resolve the inconsistency so as to make it possible to perform strict access control without impairing the convenience of the user.

That is, by searching for the variation patterns of others having a similar variation pattern as the location information of the current user through the past behavior history of business affiliates of the user, the business context that was applied to an individual who has corresponding behavior history is estimated as the business context of the user. By this, it becomes possible to resolve the inconsistency occurred between the location information measured by the terminal retained by the user and registered schedule information.

### Embodiment 3

This present embodiment, which is a method to implement strict access control, is different from previously described embodiments 1 and 2 in that business schedule and the inconsistency that is occurred between the location information of the terminal 1000 and the business schedule are recorded as past inconsistency history so as to resolve the inconsistency occurred between the current business schedule and the location information of the terminal 1000 by utilizing the past inconsistency history.

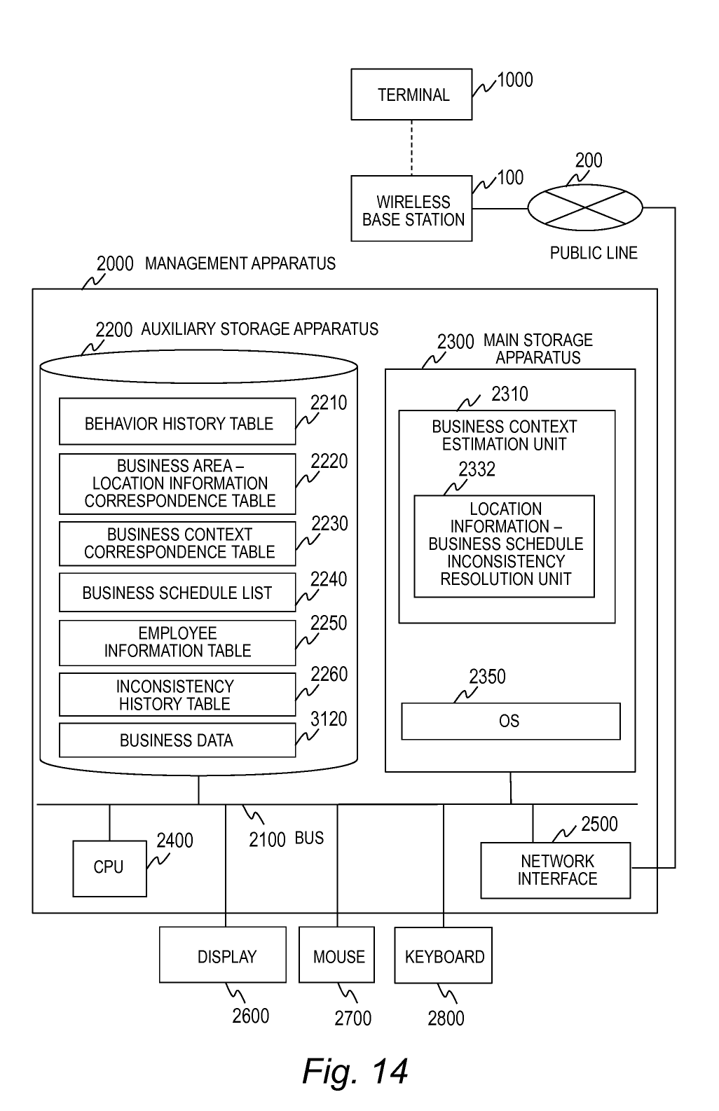

A configuration diagram of a computer system exemplifying the present embodiment is illustrated in FIG. 14. The configuration of the present embodiment is similar to that of embodiment 1 as well as that of embodiment 2. The configuration of the access control system according to the present embodiment is different from those of the previous embodiments in that the data configuration stored at the auxiliary storage apparatus 2200 at the management apparatus 2000 in FIG. 14 includes an inconsistency history table 2260 added therein, and that, although the main storage apparatus 2300 at the management apparatus 2000 includes a location information-business schedule inconsistency resolution unit 2332, which will be execute, the location information-business schedule inconsistency resolution unit 2332 takes processes that are different from those taken by the location information-business schedule inconsistency resolution units (2330 in FIG. 1, 2331 in FIG. 13) used in embodiment 1 and embodiment 2.

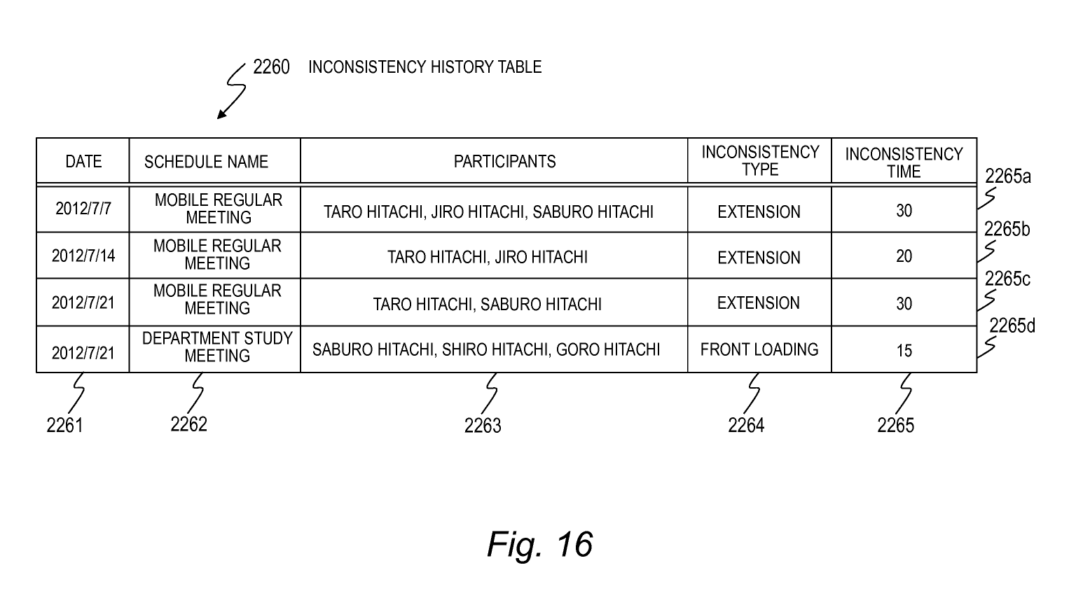

FIG. 16 is a diagram illustrating according to the present embodiment an example of a data configuration of the inconsistency history table 2260 which is used to acquire the past inconsistency information occurred from the business schedule in which the user participated previously under the same schedule name. As illustrated in FIG. 16, the inconsistency history table 2260 includes a date 2261 designed to store a date when a business schedule was conducted, a schedule name 2262 designed to store the name of the conducted business schedule, a participant 2263 designed to store the name of the individual who was registered to participate in the conducted business schedule, an inconsistency type 2264 designed to store what type of inconsistency was occurred to the conducted business schedule, and an inconsistency time 2265 designed to store the length of time the inconsistency was occurred.

The inconsistency history table 2260 illustrated in FIG. 16 is used to acquire the history of inconsistencies occurred from the same business schedule. For example, the past inconsistencies concerning the schedule titled mobile regular meeting in which Taro HITACHI participated include the information retained at the three lines including 2265a, 2265b, and 2265c in the same drawing. Further, the line indicated under 2265a indicates that the business schedule titled “mobile regular meeting” which was conducted on “Jul. 7, 2012” was extended by 30 minutes.

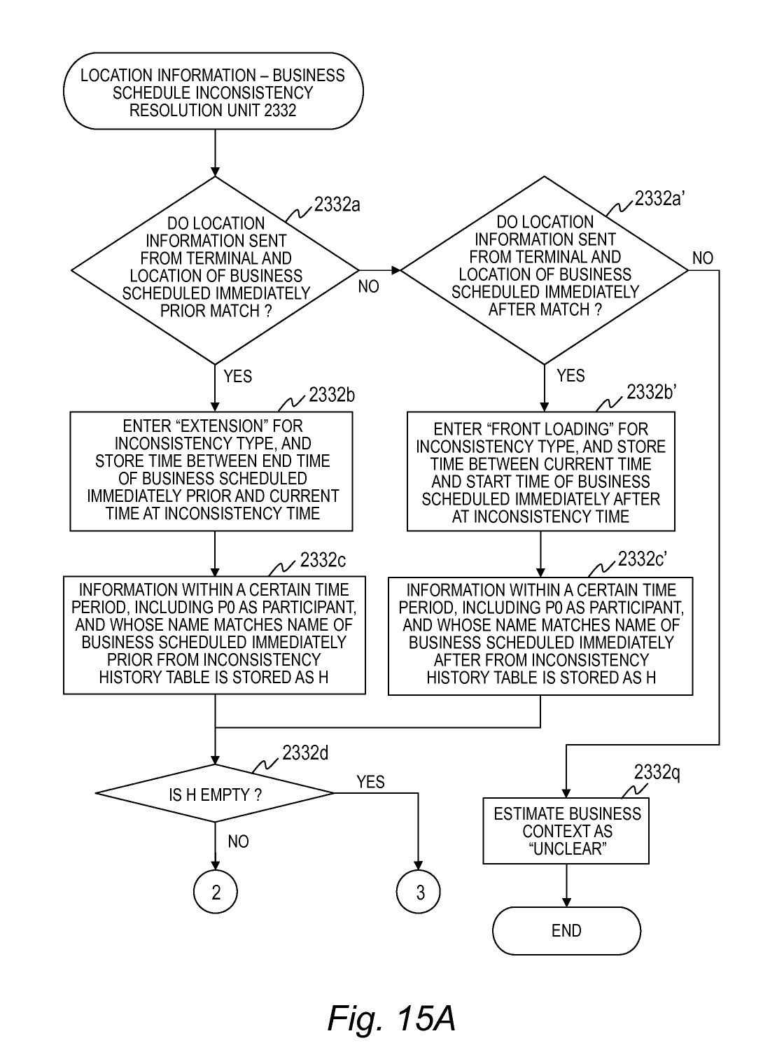

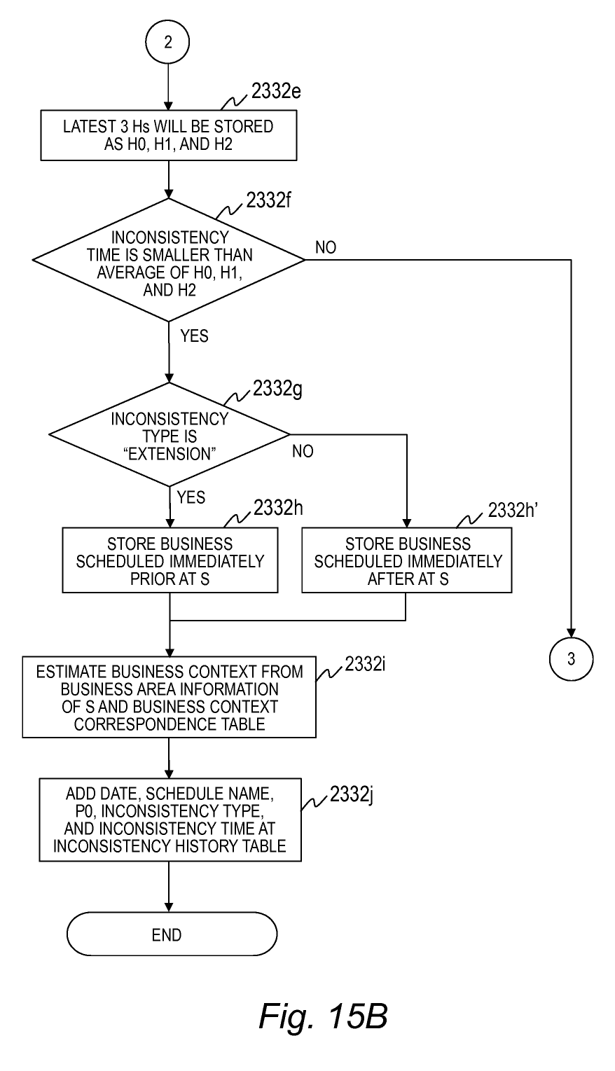

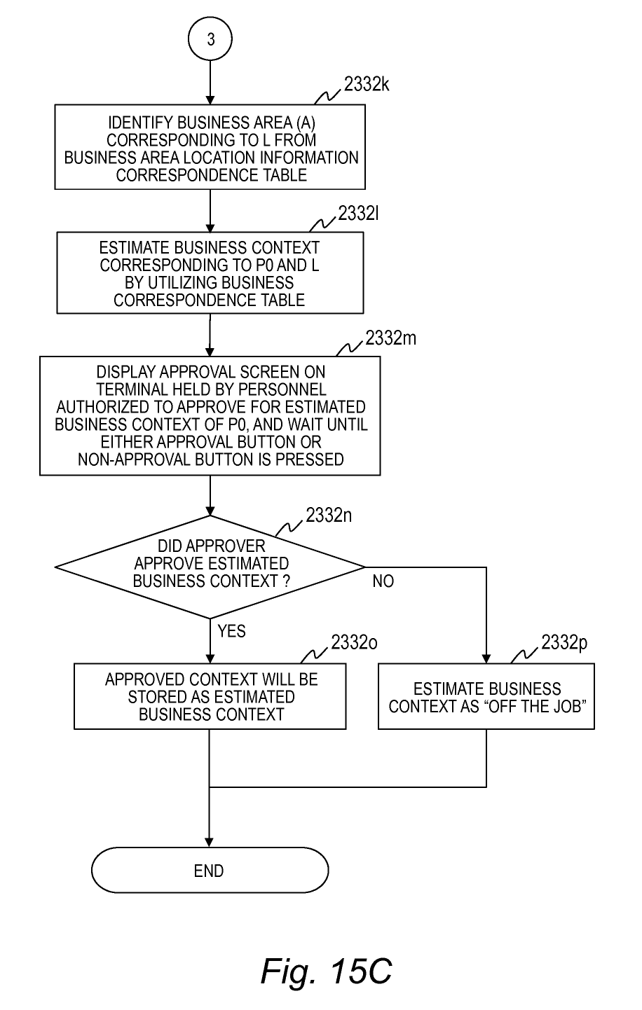

With reference to the flowcharts illustrated in FIG. 15A, FIG. 15B, and FIG. 15C, an example of a process executed by the location information-business schedule inconsistency resolution unit 2332 will be described. Note that FIG. 15A is for the first section of the flowchart; FIG. 15B is the midsection of the flowchart; and FIG. 15C is for the last section of the flowchart.

The location information-business schedule inconsistency resolution unit 2332 is a process that is executed when it is determined in Step 2313 of the business context estimation unit 2310 that an inconsistency is occurred between the business area information of the variable S and the variable L, and a process that is executed in order to resolve the currently occurred inconsistency by utilizing the history information of inconsistencies occurred in the past business schedule.

When the location information-business schedule inconsistency resolution unit 2332 is called, Step 2332a is executed first.

At Step 2332a, the location information-business schedule inconsistency resolution unit 2332 makes a determination as to whether or not the variable L corresponds to the business area 2245 of the business schedule list 2240 which was scheduled immediately prior. According to the present embodiment, the business schedule that was scheduled immediately prior includes, out of already completed business schedules, one whose scheduled end time is nearest to the current time.

At this time, in order to make a comparison between the variable L and the business area 2245 of the business schedule list 2240, the business area-location information correspondence table 2220 illustrated in FIG. 6 which was used also in embodiment 1 is used. Determining the match between the location information and the business area 2245 is carried out in the same manner as in Step 2313 in 2310 as illustrated in FIG. 10 according to the above described embodiment 1. When it is determined in Step 2332a that the location information matches the business area 2245, Step 2332b will be executed next, while when it is determined that the location information does not match the business area 2245, Step 2332a′ will be executed.

When it is determined in Step 2332a that the location matches, in Step 2332b “extension” is stored for the inconsistency type and the amount of time between the end time of the schedule immediately prior and the current time is stored in units of minutes at the inconsistency time, and the process proceeds to Step 2332c. In this case, “extension” is set because the end time of the schedule for the same location was exceeded due to the meeting being extended.

At Step 2332c, the location information-business schedule inconsistency resolution unit 2332 stores for a predetermined period of time (e.g., the inconsistency history in the past one month) from the inconsistency history table 2260 the information including the name stored at the variable P0 as participants 2263 in the same table, and the information in which the schedule name 2262 in the same table matches the name of the business schedule which was scheduled immediately therebefore at the variable H. Note that the name information of the user who made the request to estimate the business context in the business context estimation unit 2310 illustrated in FIG. 10 is stored at the variable P0.

When it is determined in Step 2332a that the location does not match, the location information-business schedule inconsistency resolution unit 2332 makes a determination as to whether or not the variable L corresponds to the business area 2245 of the business schedule list 2240 which is scheduled immediately thereafter. Also according to the present embodiment, the business schedule that was scheduled immediately thereafter includes, out of the business schedules which are scheduled in the future, one whose scheduled start time is nearest to the current time. This comparison and the determination at Step 2332a are executed at the same time. When it is determined in Step 2332a′ that the current location information matches with the business area 2245 scheduled immediately after the business schedule list 2240, Step 2332b′ is executed next, while it is determined that they do not match, Step 2332q is executed.

When it is determined in Step 2332a′ that the location matches, in Step 2332b′ “front loading” is stored at the inconsistency type 2264 and the amount of time between the current time and the start time of schedule that is scheduled immediately thereafter is stored in units of minutes, and the process proceeds to Step 2332c′.

At Step 2332c, the location information-business schedule inconsistency resolution unit 2332 stores for a predetermined period of time (e.g., the inconsistency history within one month) from the inconsistency history table 2260 the information including the name stored at the variable P0 as participants 2263 in the same table, and the information in which the schedule name 2262 in the same table matches the name of the business schedule which was scheduled immediately thereafter at the variable H.

When the step from either Step 2332c or Step 2332c′ completes, the process proceeds to Step 2332d. At Step 2332d, the location information-business schedule inconsistency resolution unit 2332 makes a determination as to whether or not the variable H is empty. When the variable H is not empty, the process proceeds to Step 2332e, and when it is empty, the process proceeds to Step 2332j.

At Step 23332e, the location information-business schedule inconsistency resolution unit 2332 acquires from the variable H information for three most recent occasions, and stores them at a variable H0, a variable H1, and a variable H2.

At Step 2332f, the location information-business schedule inconsistency resolution unit 2332 makes a comparison to see whether the inconsistency time calculated at 2332b or 2332b′ is smaller than the average inconsistency time among the variable H0, the variable H1, and the variable H2. When it is determined that it is smaller, the process proceeds to Step 2332g, and when it is determined that it is grater, the process proceeds to Step 2332j.

At Step 2332g when it is determined in Step 2332f that the current inconsistency time is smaller than the average value of the inconsistency time for the most recent 3 occasions, a determination is made as to whether or not the current inconsistency type include an extension. When the inconsistency type includes an extension, the process proceeds to Step 2332h, and when it is not extension, the process proceeds to Step 2332h′.

At Step 2332h, the location information-business schedule inconsistency resolution unit 2332 stores the business schedule which was conducted by the user immediately prior at the variable S which stores current business schedules.

At Step 2332h′, the location information-business schedule inconsistency resolution unit 2332 stores the business schedule which is scheduled to be conducted by the user immediate after at the variable S which stores current business schedules.

At Step 2332i, the location information-business schedule inconsistency resolution unit 2332 acquires from the business context correspondence table 2230 a business context which corresponds to the business area information in the variable S overwritten in Step 2332h or Step 2332h′, and stores the same as the estimated business context at the variable C.

At Step 2332j, the location information-business schedule inconsistency resolution unit 2332 adds to the inconsistency history table 2260 the current date, schedule name in the variable S, the variable P0, the inconsistency type, and inconsistency time.

When it is determined in Step 2332d that the variable H is empty, or in Step 2332f that the current inconsistency time is greater than the average of the inconsistency time of the most recent three occasions, the process proceeds to Step 2332k.

At Step 2332k, the location information-business schedule inconsistency resolution unit 2332 acquires from the business area-location information correspondence table 2220 the business area corresponding to the variable L which stores the location information of the user. The acquired business area information is stored at the variable A.

At Step 2332l, the location information-business schedule inconsistency resolution unit 2332 acquires from the business context correspondence table 2230 the business context corresponding to the variable P0 and the variable A.

At Step 2332m, the business context estimated at Step 2332l, an approval button, and a non-approval button are displayed on the screen of the terminal owned by the approver, and the process halts until either button is pressed. When the approver presses either button, the process proceeds to Step 2332n. According to the present embodiment the approver is defined as, for example, a senior manager of a department to which the user belongs, or the like, or an individual affiliated on business who has business authorities.

At Step 2332n, the location information-business schedule inconsistency resolution unit 2332 makes a determination as to whether or not the approver pressed the approval button on the business context estimated in Step 2332l. When the approval button is pressed, the process proceeds to Step 2332o, when the non-approval button is pressed, the process proceeds to Step 2332p.

When the approval button is pressed, the location information-business schedule inconsistency resolution unit 2332 determines that the business context estimated in Step 2332l is applicable to the user, and stores the business context estimated in Step 2332l at the variable C which stores estimated business contexts.

When the non-approval button is pressed, the location information-business schedule inconsistency resolution unit 2332 determines in Step 2332p that the user is currently not on the job, and stores off the job at the variable C which stores estimated business contexts.

When it is determined in Step 2332a′ that the location does not match, the process proceeds to Step 2332q, and unclear is stored at the variable C which stores estimated business contexts.

The process for the location information-business schedule inconsistency resolution unit 2332, which executes the process as described above, to, when an inconsistency is occurred between the location information of the user and the business schedule, resolve the inconsistency and to estimate the business context will be described with reference to an example.

The example illustrated in FIG. 2A assumes that Taro HITACHI participated in the mobile regular meeting (record 2245-2g) between 10:00 AM to 11:00 AM on July 28 at Yokohama Building No. 1. Further, it is assumed that the meeting started as scheduled and ended exceeding the scheduled end time by 15 minutes, and Taro HITACHI attempted to start an application over his terminal immediately after the end of the meeting at 11:15 AM. It is presupposed that, before the location information-business schedule inconsistency resolution unit 2332 is executed, the variable P0 which stores user names stores Taro HITACHI, the variable L which stores the location information of the user stores the latitude/longitude: aaa, bbb, and the wireless LAN identifier: 1F at Yokohama Building No. 1.

When it is determined in Step 2313 of FIG. 10 that the difference between the business area information of the variable S and the location information of the variable L exceeds the threshold, the location information-business schedule inconsistency resolution unit 2332 illustrated in FIG. 11 is executed.

When the location information-business schedule inconsistency resolution unit 2332 is called, Step 2332a is executed first.

At Step 2332a, the location information-business schedule inconsistency resolution unit 2332 makes a determination as to whether or not the variable L corresponds to the business schedule which is scheduled immediately prior. In this case, the business schedule scheduled immediately prior includes, out of already completed business schedules, one whose scheduled end time is nearest to the current time, which includes the business schedule indicated in the line of 2245-2g illustrated in FIG. 4. Details concerning the comparison made between the business area 2245 retained by the business schedule list 2240 and the location information acquired by the terminal 1000 include the method used in Step 2313 in the business context estimation unit 2310 illustrated in FIG. 10. According to the present example, since the business area information matches with the location information according to the method described in embodiment 1, the process proceeds to the Step 2332b of FIG. 15A.

At Step 2332b, “extension” is stored at the inconsistency type, and the inconsistency time is calculated using the time information 2244g retained by the business schedule of immediate prior and the current time. To be more specific, since the end time of the business schedule stored at 2244g is 11:00 AM, and the current time is 11:15 AM, the inconsistency time includes 15 minutes.

At Step 2332c, with reference to the inconsistency history table 2260 illustrated in FIG. 16, the information which includes the history within one month from the current time and date, and the variable P0 in the participant, and matches with the name of the schedule item “mobile regular meeting” conducted immediately prior is acquired and stored at the variable H. According to the present example, the information indicated in records 2265a, 2265b, and 2265c of FIG. 16 will be stored at the variable H.

At Step 2332d, it is determined as to whether or not the variable H is empty. As stated above, since according to the present example three piece of information is stored at the variable H, the variable H is determined as not empty, and the process proceeds to Step 2332e.

At Step 2332e, out of the information stored at the variable H, the three most recent information will be stored as the variable H0, the variable H1, and the variable H2, respectively.

At Step 2332f, it is determined as to whether or not the inconsistency time calculated in Step 2332b is smaller than the average inconsistency time among the variable H0, the variable H1, and the variable H2. Since according to the present example “30,” “20,” and “30” are stored at the variable H0, the variable H1, and the variable H2, respectively, the average among the three variables is 26 minutes and 40 seconds. Therefore, since the inconsistency time calculated in Step 2332b stores “15,” it is determined in the present Step includes that the inconsistency time is smaller than the average of the variable H0, the variable H1, and the variable H2, and the process proceeds to Step 2232g.

At Step 2332g, it is determined as to whether or not the current inconsistency type includes “extension.” Since according to the present example “extension” is stored as the inconsistency type in Step 2332b, it is determined as “extension,” and the process proceeds to Step 2332h.

At Step 2332h, it is determined by the process thus far that the business schedule which is conducted immediately prior is extending to the current time, and the business schedule of immediately prior is stored at the variable S which stores current business schedule of users. To be more specific, the information indicated in the line of 2245-2g in the business schedule list 2240 illustrated in FIG. 4 will be stored at the variable S. At Step 2332i, the business context is estimated from the variable P0 which stores users, the business area information stored at the variable S, and the business context correspondence table 2230 illustrated in FIG. 7. According to the present example, since the variable P0 includes Taro HITACHI, and the business area information of the variable S includes Yokohama Building No. 1 2245-1g for the building name, and 1F 2245-2g for the floor, the corresponding business context in the business context correspondence table 2230 illustrated in FIG. 7 includes within company (record 2233a). Therefore, the current business context of the variable P0 is estimated as within company, and “within company” is stored at the variable C which stores estimated business contexts.

Finally, at Step 2332j, the current date, the name of the business schedule estimated to be currently ongoing, the variable P0, the inconsistency type, and the inconsistency time are added to the inconsistency history table 2260. According to the present example, “Jul. 21, 2012” for the date, “mobile regular meeting” for the name of the business schedule estimated to be currently ongoing, “Taro HITACHI” stored in the variable P0 as a scheduled person, “extension” stored in Step 2332b for the inconsistency type, and “15” calculated in Step 2332b as the inconsistency time will be added.

As described above, according to the present embodiment an inconsistency occurred between a business schedule and the location information of the terminal 1000 due to the business schedule either scheduled immediately prior or after is either “front loaded” or “extended” with respect to the schedule, is resolved by utilizing the inconsistency history table 2260 which stores therein the inconsistencies that have been occurred in the past so as to make it possible to perform strict access control without impairing the convenience for the user.

That is, by storing at the inconsistency history table 2260 the past inconsistencies occurred between the location information measured by the terminal 1000 retained by the user and the registered schedule, and, when the inconsistency currently being occurred resembles the inconsistencies occurred in the past, by acquiring the type of inconsistencies occurred in the past and a schedule name, it becomes possible to estimate the business context corresponding to the schedule name as the user's business context.

Note that the present invention is not limited to the embodiments described herein, and may include various modifications. For example, the above described embodiments are described in detail to facilitate the description thereof, and are not intended to impose limitations on the present invention to necessarily include the configuration as described herein. Further, replacements may be made between one embodiment to another, and adding the structure of another embodiment in the structure of certain embodiments are possible. For example, embodiment 1 and embodiment 2 may be combined. Furthermore, portions of one embodiment may be added, deleted, or replaced with those of another embodiment.

What is claimed is:

1. An access control method for a terminal coupled with a management apparatus having a processor and a memory, the method comprising:
a first step for storing, by the management apparatus, at a schedule storage unit location information corresponding to time of an owner of the terminal;
a second step for transmitting, by the terminal, after acquiring the location information and time information to the management apparatus an identifier of the owner of the terminal, the location information, and the time information;
a third step for determining, by the management apparatus, an inconsistency is occurred to one of at least the location information and the time information after comparing the identifier of the owner received from the terminal, the location information, the time information with location information corresponding to time for the owner of the terminal stored at the schedule storage unit, and when location information corresponding to the time information of the terminal is in disagreement with location information corresponding to time stored at the schedule storage unit;
a fourth step for transmitting, by the management apparatus, a business status to the terminal when the inconsistency is occurred after estimating a business status of the owner of the terminal from history information of a person related to the owner of the terminal; and
a fifth step for controlling access, by the terminal, to an application and data according to the business status after receiving the business status.

2. The access control method according to claim 1,
wherein history information of the person related to the owner of the terminal includes behavior history information which includes an accumulation of location information and business status corresponding to time information of a terminal of the person related to the owner of the terminal, and
wherein a fourth step includes, estimating the business status of the owner of the terminal from a business status of a person related to the owner of the terminal when the time information of the owner of the terminal is the same with time information of the terminal of the person related to the owner of the terminal and when the location information of the owner of the terminal and the location information of the terminal of the person related to the owner of the terminal are within a predetermined range.

3. The access control method according to claim 1,
wherein the history information of the person related to the owner of the terminal includes behavior history information which includes an accumulation of the location information and the business status corresponding to the time information of the terminal of the person related to the owner of the terminal, and
wherein the fourth step includes,
acquiring a first variation pattern of the location information of the owner of the terminal, extracting, out of a second pattern of past location information of the terminal of the person related to the owner of the terminal, the second variation patter corresponding to the first variation pattern, and estimating the business status of the owner of the terminal from the business status of the person related to the owner of the terminal.

4. The access control method according to claim 1,
wherein the history information of the person related to the owner of the terminal includes inconsistency history information storing therein history of an inconsistency occurred in the location information of the terminal and location information of the schedule storage unit, and business status information having stored therein the location information and the business status,
wherein the fourth step includes acquiring from the inconsistency history information history corresponding to the inconsistency of the owner of the terminal, acquiring from the location information included in the acquired history a business status, and estimating the business status of the owner of the terminal from the business status.

5. The access control method according to claim 1, wherein the fifth step for restricting and canceling a type of an application activated by the terminal, a device operated by the terminal, and data accessed according to the business status.

6. The access control method according to claim 1, wherein the person related to the owner of the terminal includes at least one of a department of an organization the owner of the terminal belongs and a business conducted by the owner of the terminal.

7. A management apparatus having a processor and a memory, and an access control system having a terminal coupled with the management apparatus having a processor and a memory,
wherein the terminal includes:
a basic data acquisition unit configured to acquire time information and location information;
an activation control unit configured to control access to an application and data according to a business status; and
a communication unit configured to transmit to the management apparatus the time information, the location information, and an identifier of an owner of the terminal, and to receive from the management apparatus the business status,
wherein the management apparatus includes:
a communication unit configured to receive from the terminal the identifier of the owner, the location information and the time information, and to transmit to the terminal the business status;
a schedule storage unit configured to store therein the location information corresponding to time for the owner of the terminal; and
a business status estimation unit configured to compare the identifier of the owner, the location information, and the time information received from the terminal to location information corresponding to time for the owner of the terminal stored at the schedule storage unit, to determine an inconsistency is occurred to at least one of the location information and the time information when the location information corresponding to the time information of the terminal is in disagreement with location information corresponding to time stored at the schedule storage unit, and to estimate, when the inconsistency is occurred, a business status of the owner of the terminal from history information of the person related to the owner.

8. The access control system according to claim 7, wherein history information of the person related to the owner of the terminal include behavior information which includes an accumulation of location information and business status corresponding to time information of a person related to the owner of the terminal, and the business estimation unit estimates the business status of the owner of the terminal from a business status of a person related to the owner of the terminal when the time information of the owner of the terminal is the same with time information of the terminal of the person related to the owner of the terminal and when the location information of the owner of the terminal and the location information of the terminal of the person related to the owner of the terminal are within a predetermined range.

9. The access control system according to claim 7,
wherein the history information of the person related to the owner of the terminal includes behavior history information which includes an accumulation of the location information and the business status corresponding to the time information of the terminal of the person related to the owner of the terminal, and
wherein the business status estimation unit acquires a first variation pattern of the location information of the owner of the terminal, extracting, out of a second pattern of past location information of the terminal of the person related to the owner of the terminal, the second variation patter corresponding to the first variation pattern, and estimating the business status of the owner of the terminal from the business status of the person related to the owner of the terminal.

10. The access control system according to claim 7,
wherein the history information of the person relate to the owner of the terminal includes inconsistency history information storing therein history of an inconsistency occurred in the location information of the terminal and location information of the schedule storage unit, and business status information having stored therein the location information and the business status,
wherein the business status estimation unit acquires from the inconsistency history information history corresponding to the inconsistency of the owner of the terminal, acquires from the location information included in the acquired history a business status, and estimates the business status of the owner of the terminal from the business status.

11. The access control system according to claim 7, wherein the activation control unit restricts and cancels a type of an application activated by the terminal, a device operated by the terminal, and data accessed according to the business status.

12. The access control system according to claim 7, wherein the person related to the owner of the terminal includes at least one of a department of an organization the owner of the terminal belongs and a business conducted by the owner of the terminal.
